(19) United States
(12) Patent Application Publication
(10) Pub. No.: US 2015/0271631 A1
(43) Pub. Date: Sep. 24, 2015

(54) Mobile Network for On-site Management of an Event

(71) Applicant: Eventbrite, Inc., San Francisco, CA (US)

(72) Inventor: Sean William Porter, San Francisco, CA (US)

(73) Assignee: Eventbrite, Inc., San Francisco, CA (US)

(21) Appl. No.: 14/221,223

(22) Filed: Mar. 20, 2014

(51) Int. Cl. H04W 4/02; H04L 29/08

(52) U.S. Cl. CPC H04W 4/02; H04L 67/18

(57) ABSTRACT

In one embodiment, a method includes by one or more processors associated with a first mobile check-in device, the first mobile check-in device being associated with a first check-in location of a multiple of check-in locations at a venue for an event: receiving, by one or more of the processors, an event attendee list associated with the event, the event attendee list identifying, for each of a multiple of attendees of the event: an attendee identifier associated with the attendee; and whether the attendee is checked-in or not checked-in; checking-in, by one or more of the processors, one or more attendees with the first mobile check-in device, wherein checking-in an attendee includes: receiving an indication that the attendee has arrived at the event; updating the check-in status of the attendee in the event attendee list to identify that the attendee is checked-in at the first check-in location associated with the first mobile check-in device; transmitting, by one or more of the processors, to a second mobile check-in device a first updated event attendee list identifying the attendees checked-in with the first mobile check-in device; and receiving, by one or more of the processors, from the second mobile check-in device a second updated event attendee list that identifies one or more attendees who have checked-in with the second mobile check-in device.

### TECHNICAL FIELD

The present disclosure generally relates to event management systems and systems for managing and monitoring ticket processing and attendee check-in at events.

### BACKGROUND

Entry management at events is a long established problem. Typically, event organizers will have someone man the door equipped with a clipboard, a list of all the registered attendees printed on paper and a pen to mark off those who have entered. The process is time consuming and breaks down when an event has multiple locations with multiple points of entry. Entry lines will often be long and slow as the person at the door looks up each person on the list. When multiple locations are involved, a person could sneak into the event by giving the name of a person that went in the other door.

Event management information can be stored in relational databases. Generally, a relational database is a collection of relations (frequently referred to as tables). Relational databases use a set of mathematical terms, which may use structured query language (SQL) database terminology. MySQL is a relational database management system (RDBMS) that runs as a server providing multi-user access to a number of databases. SQLite is a software library that implements a self-contained, serverless, zero-configuration, transactional SQL database engine.

### BRIEF DESCRIPTION OF THE DRAWINGS

FIG. 1 illustrates a system that provides on-site management of spectator entry into an event.

FIG. 2 illustrates an example system for implementing an on-line gatekeeper system in order to provide on-site management of spectator entry into an event.

FIG. 3 illustrates an example computing server.

FIG. 4 illustrates an example block diagram of mobile check-in device.

FIG. 5A illustrates an example mobile check-in device.

FIG. 5B illustrates an example mobile check-in device.

FIG. 5C illustrates an example mobile check-in device.

FIG. 5D illustrates an example mobile check-in device.

FIG. 5E illustrates an example mobile check-in device.

FIG. 5F illustrates an example mobile check-in device.

FIG. 5G illustrates an example mobile check-in device.

FIG. 6 illustrates an example method for facilitating checking-in one or more attendees with a plurality of mobile check-in devices.

FIG. 7 illustrates an example system for implementing local SQL files for mobile check-in devices with an event management system.

FIG. 8 illustrates an example method for setting up new mobile check-in devices with a gatekeeper system.

FIG. 9 illustrates an example method for managing requests for event attendee lists from mobile check-in devices by a gatekeeper system.

FIG. 10 illustrates an example computer system.

### DESCRIPTION OF EXAMPLE EMBODIMENTS

### Gatekeeper Systems

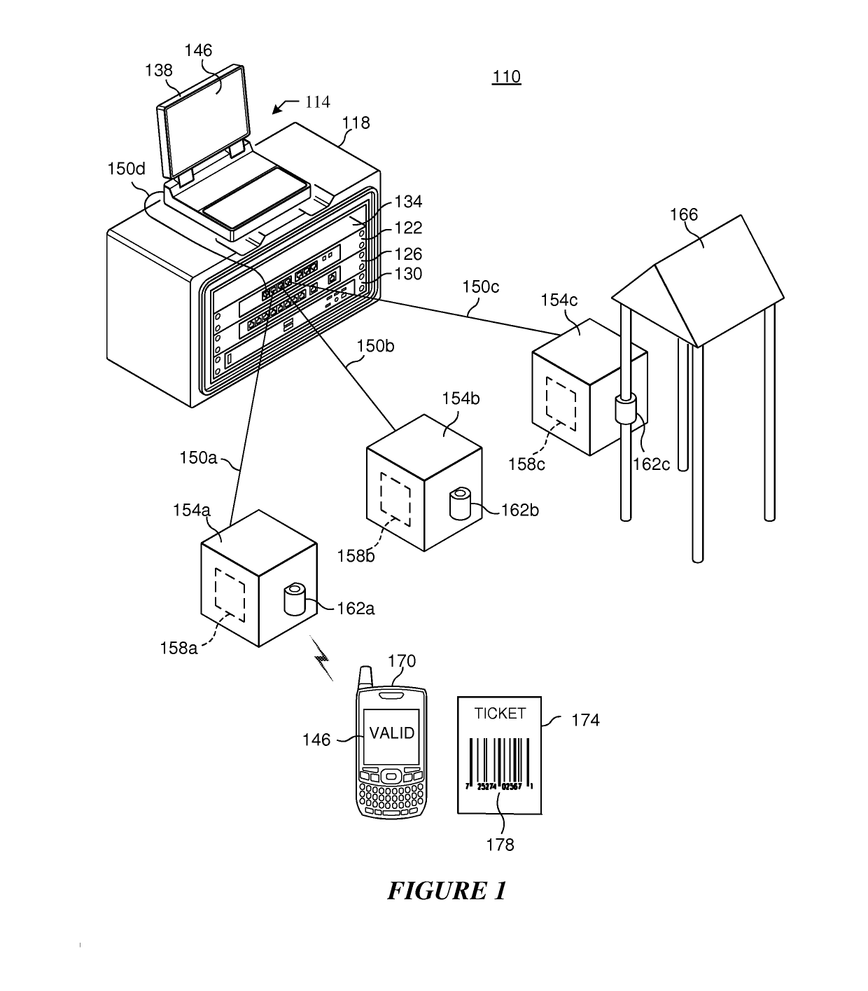

FIG. 1 illustrates a system 110 that provides on-site management of spectator entry into an event. System 110 includes a gatekeeper system 114 that may manage entry of spectators into an event by providing an indication of validity 146 for a ticket 174 presented by a spectator attempting entry into the event. According to the illustrated embodiment, gatekeeper system 114 may include a protective casing 118 that protects gatekeeper system 114 from one or more environmental conditions that may be present on-site at an event. In particular embodiments, protective casing 118 may be a portable, ruggedized, and waterproof casing that houses a router 122, a switch 126, an uninterrupted power supply 130, and a computing server 138, each of which may assist gatekeeper system 114 in providing the indication of validity 146 of the ticket 174 presented by a spectator at the event. In particular embodiments, since protective casing 118 is a portable, ruggedized, and waterproof casing, gatekeeper system 114 may be easily transported to an event, and set up to provide on-site management of spectator entry into the event without subjecting the components of gatekeeper system 114 to the environmental conditions on-site. In particular embodiments, since gatekeeper system 114 includes each of router 122, switch 126, uninterrupted power supply 130, and computing server 138 (all housed in protective casing 118) gatekeeper system 114 may be easily transported to and set up on-site to provide on-site management of spectator entry into an event.

As discussed above, gatekeeper system 114 provides the indication of validity 146 of the ticket 174 presented by a spectator attempting to enter an event. An event may be, for example, a party, a concert, a conference, a sporting event, a fundraiser, a networking event, or a live performance. Although various event forums may have built-in systems for managing spectator entry into the event (such as football stadiums), many events may occur in locations where a built-in system for managing spectator entry is unavailable. For example, some events may occur in parking lots, open fields, fairgrounds, buildings that typically do not host events, and/or other locations where a built-in system for managing spectator entry is not available. Furthermore, many of these locations may have conditions (such a little to no protection from wind, rain, mud, etc.) that are unsuitable for electronic systems. In particular embodiments, gatekeeper system 114 may manage entry of spectators into an event. Furthermore, gatekeeper system 114 may include a protective casing 118 that protects gatekeeper system 114 from one or more environmental conditions that may be present on-site at an event.

According to the illustrated embodiment, gatekeeper system 114 may include protective casing 118, router 122, switch 126, uninterrupted power supply 130, storage area 134, and computing server 138. In particular embodiments, gatekeeper system 114 may include any other components for providing the indication of validity 146 of the ticket 174 presented by a spectator attempting entry at an event.

Protective casing 118 represents any components that may protect gatekeeper system 114 from one or more conditions that may be present on-site at an event. In particular embodiments, protective casing 118 may be a portable casing. As such, protective casing 118 (and any components of gatekeeper system 114 located inside of protective casing 118) may be easily transported to and from an event. In particular embodiments, protective casing 118 may be carried by three people or less. In particular embodiments, protective casing 118 may be a ruggedized casing. As such, protective casing 118 (and any components of gatekeeper system 114 located inside of protective casing 118) may be protected from rough handling and accidents that may occur on-site at the event. For example, protective casing 118 may be accidentally dropped from small heights (such as less than 3 feet) without damaging (or substantially damaging) one or more components of gatekeeper system 114. In particular embodiments, protective casing 118 may be a waterproof casing. As such, protective casing 118 (and any components of gatekeeper system 114 located inside of protective casing 118) may be protected from liquids (such as water) and/or mixtures of liquids and solids (such as mud). In particular embodiments, protective casing 118 may be a portable, ruggedized, and/or waterproof casing.

Protective casing 118 may be made of any material type that allows it to be portable, ruggedized, and/or waterproof. For example, protective casing 118 may be made out of a polypropylene copolymer material that is lightweight, durable and highly chemical resistant.

Router 122 may represent any components that may join two or more wired or wireless networks together so as to route data between the networks. Router 122 may include any suitable router. For example, router 122 may include a multi-wide area network (WAN) router. As such, router 122 may load balance between various network connections so as to provide optimum connectivity. In particular embodiments, router 122 may include any router available from Peplink, such as the Peplink Balance 130, or any router available from any other router manufacturer or provider.

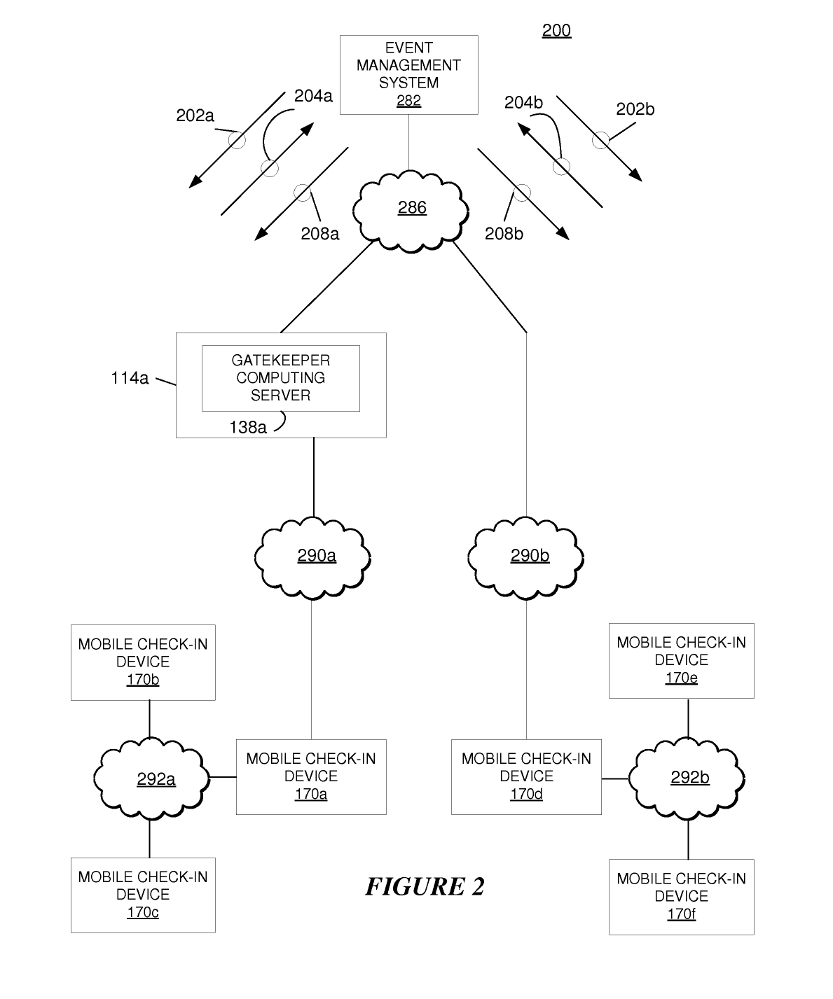

In particular embodiments, router 122 may couple gatekeeper system 114 to one or more networks so that ticket information 328 stored on computing server 138 may be updated from a master ticket information 328 for the event, as is discussed in further detail in FIG. 2. In particular embodiments, this may allow computing server 138 to have the most current information with regard to the event being managed.

In particular embodiments, router 122 may connect to a WAN at the operating site of the event (such as by connecting directly to a digital subscriber line (DSL) available at the operating site of the event). In particular embodiments, if a WAN is not available at the operating site of the event, router 122 may connect to any suitable network (such as networks provided by a mobile router, a mobile WiFi device, and/or media center bridges).

Router 122 may include any number of connection ports and any type of connection ports for joining two or more wired or wireless networks together. For example, router 122 may include Universal Serial Bus (USB) connection ports, Ethernet cabling connection ports (such as connection ports for category 5 cable), any other connection ports, or any combination of the preceding. In particular embodiments, router 122 may be located inside of protective casing 118. As such, router 122 may be protected from the outside environment throughout its operation.

Switch 126 may represent any components that join two or more computing systems together into a single network. For example, switch 126 may join two or more computing servers together into a single local area network (LAN). In particular embodiments, switch 126 may include any type of switch. For example, switch 126 may include any switch available from Cisco Systems, Inc., such as the Cisco SF302-08P, or any switch available from any other switch manufacturer or provider.

In particular embodiments, switch 126 may be a power over Ethernet (POE) switch that may route both electrical power and data between multiple computing servers. According to the illustrated embodiment, switch 126 may connect access points 158 to computing server 138. As such, not only may switch 126 provide power for each access point 158 and also for computing server 138, but switch 126 may further route data packets between access points 158 and computing server 138.

Switch 126 may include any number of connection ports and any type of connection ports for joining two or more computing servers together into a single network. For example, switch 126 may include USB connection ports, Ethernet cabling connection ports (such as connection ports for category 5 cable), any other connection ports, or any combination of the preceding. In particular embodiments, switch 126 may be located inside of protective casing 118. As such, switch 126 may be protected from the outside environment throughout its operation.

Uninterrupted power supply 130 may represent any components that may provide power to one or more components of system 110 if an input power source is unavailable. Uninterrupted power supply 130 may include any type of uninterrupted power supply. For example, uninterrupted power supply 130 may include any uninterrupted power supply available from APC, such as the APC SC450RM1U, or any uninterrupted power supply available from any other uninterrupted power supply manufacturer or provider.

In particular embodiments, uninterrupted power supply 130 may be connected to an input power source at the operating site of the event. When the input power source is providing power, uninterrupted power supply 130 may provide the power received from the power source to access points 158 and/or components of gatekeeper system 114 (such as computing server 138). In particular embodiments, such power may be provided to access points 158 and computing server 138 though switch 126. On the other hand, if a power source at the operating site of the event is unavailable or non-operational, uninterrupted power supply 130 may supply power stored at uninterrupted power supply 130 to access points 158 and/or components of gatekeeper system 114. In particular embodiments, uninterrupted power supply 130 may provide stored power for any amount of time. For example, uninterrupted power supply 130 may provide stored power for five minutes, ten minutes, one hour, two hours, four hours, eight hours, or any other amount of time. In particular embodiments, uninterrupted power supply 130 may keep each of the access points 158 and the components of gatekeeper system 114 running for up to six hours.

In particular embodiments, uninterrupted power supply 130 may be located inside of protective casing 118. As such, uninterrupted power supply 130 may be protected from the outside environment throughout its operation.

Storage area 134 may represent an area in protective casing 118 that may store computing server 138 when computing server 138 is not in use. For example, when computing server 138 is not operating (such as when gatekeeper system 114 is not yet set up at a particular event), computing server 138 may be stored in storage area 134. Thus, computing server 138 may be protected by protective casing 118. In particular embodiments, prior to computing server 138 being turned on for operation, computing server 138 may be removed from storage area 134 and connected to gatekeeper system 114 (such as through switch 126).

Storage area 134 may have any suitable size and shape. For example, storage area 134 may store a computing server 138 of any size. Furthermore, although storage area 134 has been described as storing computing server 138, in particular embodiments, storage area 134 may further store other components of gatekeeper system 114, such as one or more connectors that may be used to connect various devices to gatekeeper system 114. Additionally, although computing server 138 has been described as being stored in storage area 134 of protective casing 118, and removable from storage area 134 when computing server 138 is in operation, in particular embodiments, computing server 138 may be located inside of protective casing 118 while in operation.

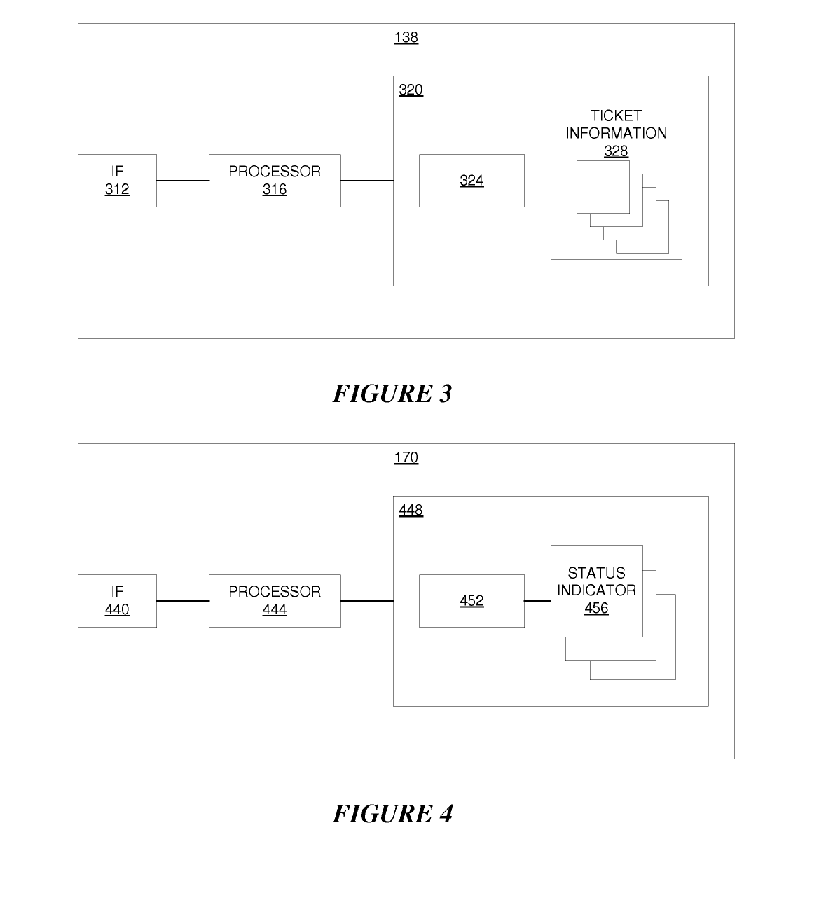

Computing server 138 may represent any components that may determine the indication of validity 146 of ticket 174, and communicate the indication of validity 146. Computing server 138 may include any suitable computing device, such as, for example, a network server, any remote server, a mainframe, a host computer, a workstation, a personal computer, a laptop, a cellular phone, a smartphone, a personal digital assistant, an ultra-mobile PC, or a computing tablet. Particular embodiments of computing server 138 are further described in FIG. 3. One or more computing servers 138 may be associated with an event management system 282, a gatekeeper system 114, or both.

Indication of validity 146 may represent any indication regarding the validity of ticket 174. For example, indication of validity 146 may indicate that ticket 174 is valid, and therefore the spectator that has presented ticket 174 may be allowed to enter the event. In particular embodiments, indication of validity 146 may indicate that ticket 174 is invalid and therefore the spectator that has presented ticket 174 may not be allowed to enter the event. In addition to indicating the validity of ticket 174, indication of validity 146 may further provide further information regarding ticket 174. For example, indication of validity 146 may further indicate that ticket 174 is valid but entry into the event is not allowed at this time for ticket 174. For example, if certain tickets allow for earlier entry into an event than other tickets, indication of validity 146 may indicate that the ticket 174 is valid, but that entry using the ticket 174 is not permitted at this time. As another example, indication of validity 146 may further indicate that although ticket 174 is valid, ticket 174 may not be used at a particular entry location for the event. For example, particular tickets may require that the tickets be presented at a particular gate. As such, if ticket 174 is presented at the wrong gate, indication of validity 146 may indicate that although ticket 174 is valid, it may not be used to enter at that particular gate.

According to the illustrated embodiment, computing server 138 and access points 158 may be connected to switch 126 of gatekeeper system 114 by switch connectors 150. Switch connector 150 may represent any connector that connects a device to switch 126 so that switch 126 may provide data and/or electrical power to the device. In particular embodiments, switch connector 150 may be any type of connector. For example, switch connector 150 may be a category 5 cable. In particular embodiments, switch connector 150 may be rubberized so as to protect it from environments encountered at the event. In particular embodiments, switch connector 150 may have any length so as to connect access points 158 (and/or other devices) to switch 126 over any distance.

Access point protective casing 154 may represent any components that may protect access point 158 from one or more conditions that may be present on-site at an event. In particular embodiments, access point protective casing 154 may be a portable casing. As such, access point protective casing 154 (and access point 158) may be easily transported to and from an event. In particular embodiments, access point protective casing 154 may be carried by one person. In particular embodiments, access point protective casing 154 may be a ruggedized casing. As such, access point protective casing 154 (and access point 158) may be protected from rough handling and accidents that may occur on-site at the event. For example, access point protective casing 154 may be accidentally dropped from small heights (such as less than 3 feet) without damaging (or substantially damaging) access point 158. In particular embodiments, access point protective casing 154 may be a waterproof casing. As such, access point protective casing 154 (and access point 158) may be protected from liquids (such as water) and/or mixtures of liquids and solids (such as mud). In particular embodiments, access point protective casing 154 may be a portable, ruggedized, and/or waterproof casing.

Access point protective casing 154 may be made of any material type that allows it to be portable, ruggedized, and/or waterproof. For example, access point protective casing 154 may be made out of a polypropylene copolymer material that is lightweight, durable and highly chemical resistant.

According to the illustrated embodiment, access points 158 may be positioned within respective access point protective casings 154. Access point 158 may represent any components for receiving and transmitting radio signals for a wireless network. In particular embodiments, access point 158 may receive and transmit radio signals for a wireless local area network (WLAN). In particular embodiments, the WLAN may include WiFi, WiMax, BlueTooth, or other suitable standards. Access point 158 may be any type of access point. For example, access point 158 may include any access point available from Cisco Systems, Inc., such as the Cisco 1262 access point, or any access point available from any other access point manufacturer or provider.

In particular embodiments, access point 158 may be a wireless access point. In particular embodiments, access point 158 may receive and send radio signals over any suitable distance. For example, access point 158 may receive and send radio signals across a distance of over 80 feet in each direction. As such, mobile check-in device 170 may be located anywhere within the 80 feet distance from access point 158 and may still communicate with access point 158.

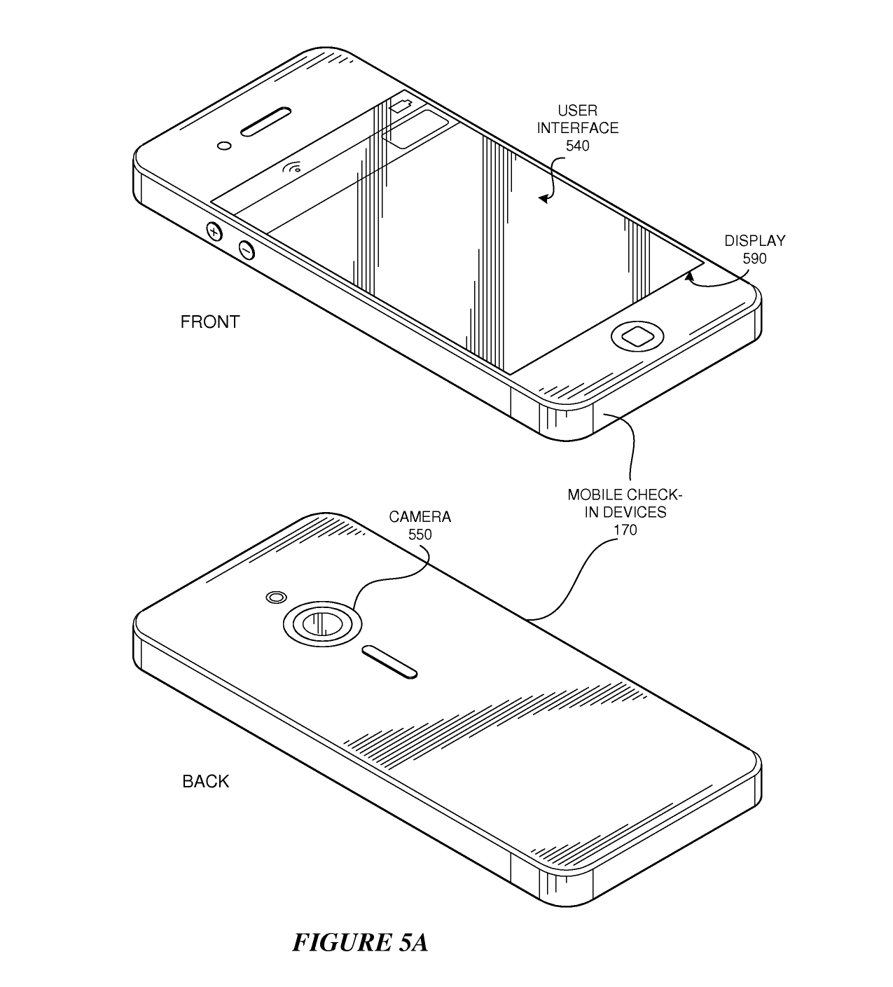

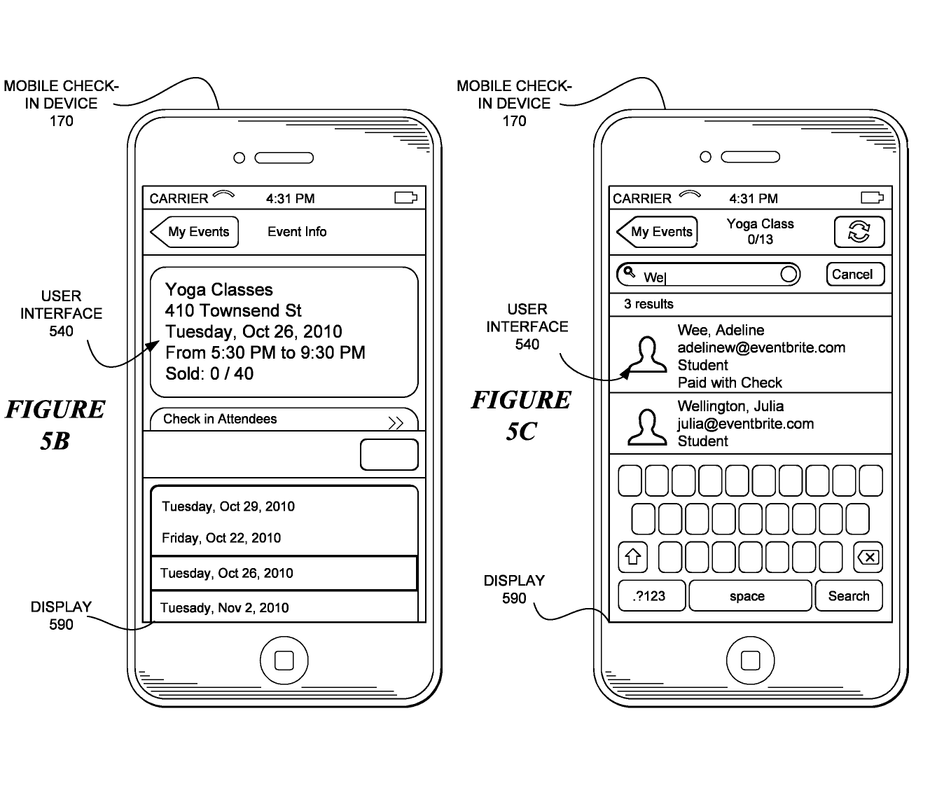

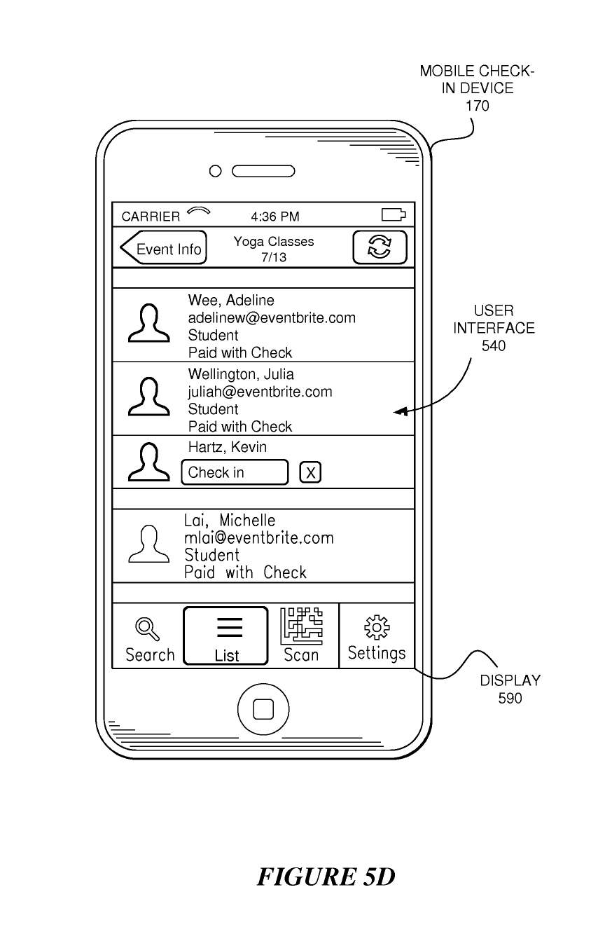

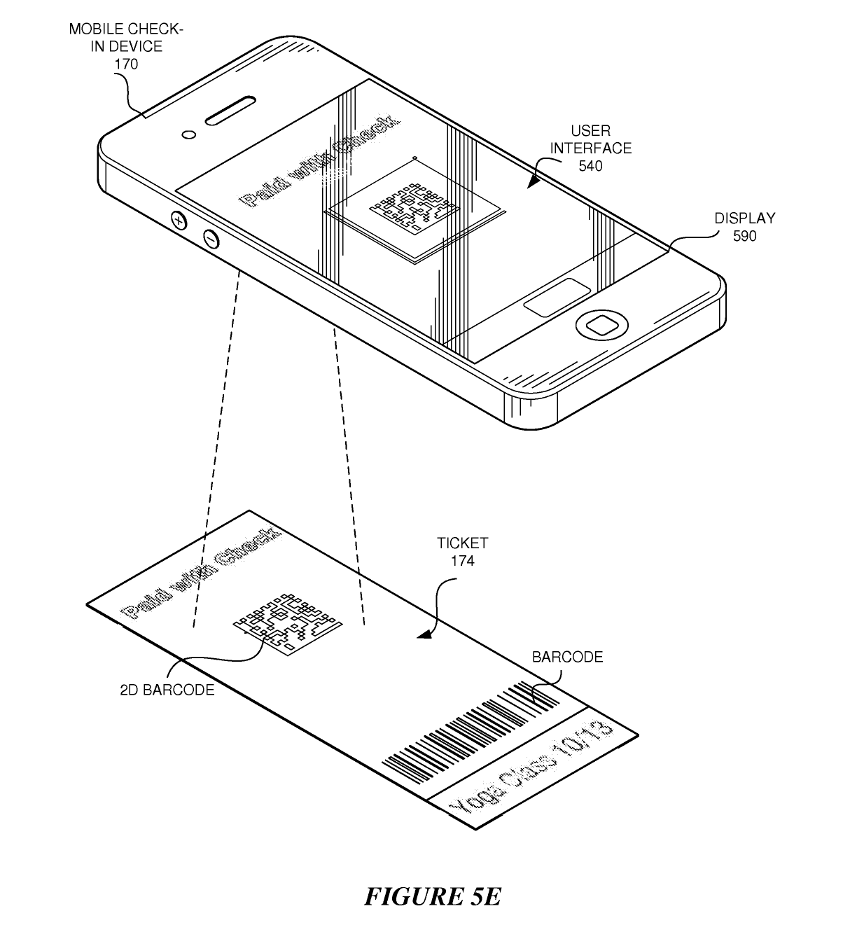

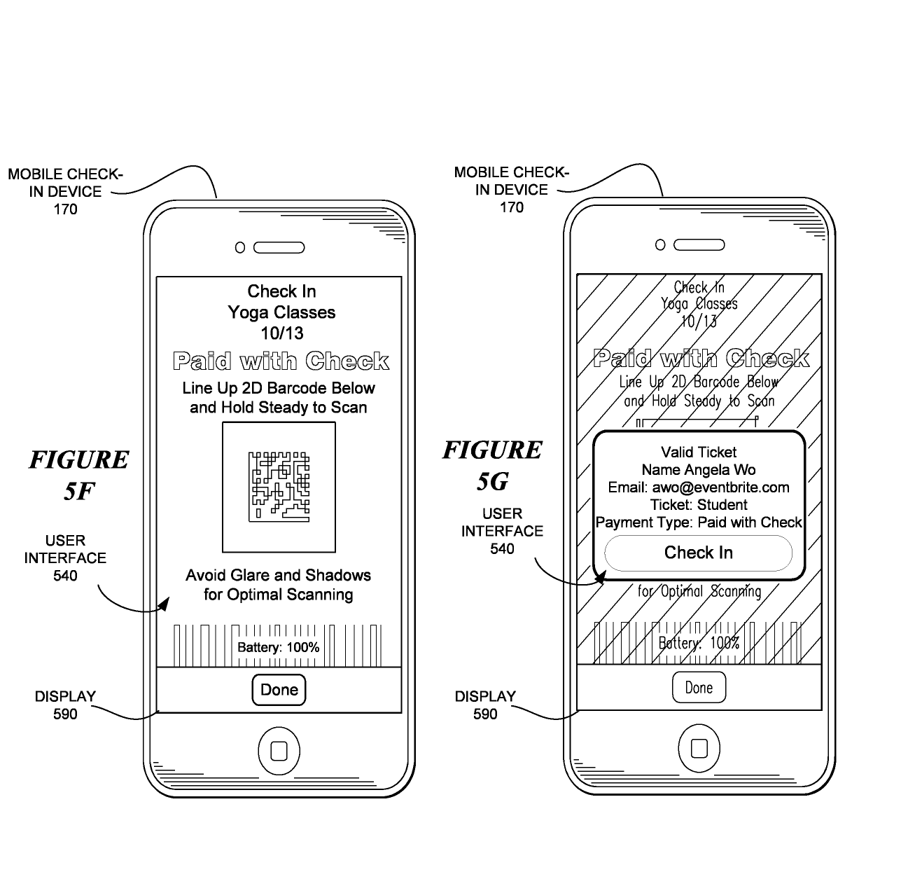

In particular embodiments, access point 158 may be a dual frequency access point. For example, access point 158 may broadcast in two different frequencies, such as 5 GHz and 2.5 GHz. In particular embodiments, access point 158 may operate in accordance with any IEEE 802.11 WLAN standard, such as A, B, G, and/or N. In particular embodiments, access point 158 may receive data from mobile check-in device 170 and transmit the data to computing server 138. In particular embodiments, access point 158 may receive data from computing server 138 and transmit the data to mobile check-in device 170. In particular embodiments, mobile check-in device 170 may represent one or more components that communicate with computing server 138 in order to receive the indication of validity 146 of ticket 174. In particular embodiments, mobile check-in device 170 may represents any components that determine the indication of validity 146 of ticket 174, and communicate the indication of validity 146. Mobile check-in device 170 may include any suitable computing device, such as, for example, a personal computer, a laptop, a cellular phone, a smartphone, a personal digital assistant, an ultra-mobile PC, a computing tablet, another suitable computing device, or any combination thereof. In particular embodiments, mobile check-in device 170 may include any mobile computing system available from Apple, such as the Apple IPAD or IPHONE, or any mobile system available from any other mobile device manufacturer or provider. Particular embodiments of mobile check-in device 170 are further described in FIG. 4 and FIG. 5.

In particular embodiments, access point 158 may be autonomous or a so-called “fat” wireless access point or a light-weight wireless access point operating in connection with a wireless switch, such as switch 126. In addition, the network infrastructure may also include a Wireless LAN Solution Engine (WLSE) offered by Cisco Systems, Inc. or another wireless network management system. In some implementations, the network infrastructure may also include one or more Wireless Control System (WCS) nodes operative to manage one or more wireless switches and access points.

According to the illustrated embodiment, access point protective casing 154 may further include connector 162. Connector 162 may represent any connector (such as a clamp) that may connect access point protective casing 154 to a support structure. For example, in order for access point 158 to better receive radio signals from mobile check-in device 170, access point protective casing 154 (which includes access point 158) may be positioned off the ground. As such, connector 162 may couple access point protective casing 154 to support structure 166 so as to hold access point protective casing 154 off the ground. In particular embodiments, connector 162 may couple access point protective casing 154 to any suitable support structure. For example, connector 162 may couple access point protective casing 154 to a pole of a tent, a speaker stand, a fence, scaffolding, standard rigging, or any other support structure at the event.

In particular embodiments, access point protective casing 154 may further include any connection port for connecting access point 158 to switch 126. For example, access point protective casing 154 may include an Ethernet card connection that is accessible from the outside of access point protective casing 154.

In particular embodiments, mobile check-in device 170 may scan ticket identifier 178 of ticket 174, and communicate the ticket identifier 178 to computing server 138 in order to receive the indication of validity 146 of ticket 174. In particular embodiments, mobile check-in device 170 may scan ticket identifier 178 in any manner. For example, mobile check-in device 170 may include any suitable scanning device, such as, for example a camera, an optical scanner, a barcode scanner, a QR code scanner, or any another scanning device. In particular embodiments, mobile check-in device 170 may further include a display for displaying the indication of validity 146. As such, a user of mobile check-in device 170 may allow the spectator to enter the event or prevent the spectator from entering the event. In particular embodiments, while mobile check-in device 170 is operating in system 110, one or more functionalities of mobile check-in device 170 may be shut down. For example, mobile check-in device 170 may only be able to perform functionalities related to the event management (such as scanning).

Ticket 174 may represent any object that may be used to gain access to the event. According to the illustrated embodiment, ticket 174 may include ticket identifier 178. Ticket identifier 178 may include any identifier scanned by mobile check-in device 170 in order to determine whether ticket 174 is valid or not. In particular embodiments, ticket identifier 178 may be an identification number, a barcode, a 2D barcode, a QR code, or another suitable identifier. In particular embodiments, ticket identifier 178 may be an unique identifier.

In an example embodiment of operations, a spectator may desire to enter a particular event. In order to do so, the spectator may present ticket 174 to a user with mobile check-in device 170. Mobile check-in device 170 may scan ticket identifier 178 from ticket 174 and transmit ticket identifier 178 to computing server 138. Based on ticket identifier 178, computing server 138 may generate the indication of validity 146 of ticket 174. Computing server 138 may then transmit the indication of validity 146 to mobile check-in device 170 (via switch 126 and access point 158a) so that mobile check-in device 170 may display the indication of validity 146. For example, mobile check-in device 170 may display an indication of validity 146 that indicates that ticket 174 is valid. As such, the user of mobile check-in device 170 may allow the spectator with ticket 174 to enter the event. In particular embodiments, since the components of gatekeeper system 114 are protected by protective casing 118, such management of spectator entry may occur on-site, even in poor conditions.

Modifications, additions, or omissions may be made to system 110 without departing from the scope of the invention. For example, gatekeeper system 114 may include an access point 158 located in protective casing 118. Additionally, system 110 may include any number of gatekeeper systems 114 (and/or components of gatekeeper systems 114), access point protective cases 154 (and/or access points 158), and/or mobile check-in devices 170. Any suitable logic may perform the functions of system 110 and the components within system 110.

FIG. 2 illustrates an example system 200 for implementing an on-line gatekeeper system in order to provide on-site management of spectator entry into an event. System 200 may include an event management system 282 that is connected to gatekeeper systems 114 through network 286. System 200 may also include mobile check-in devices 170 connected to event management system 282, either directly or via gatekeeper systems 114, through networks 290. Furthermore, system 200 may include mobile check-in devices connected to each other via networks 292.

In particular embodiments, event management system 282 may be a network-addressable computing server that can host one or more event organization and management systems. Event management system 282 may generate, store, receive, and transmit event-related data, such as, for example, event listings, event details, event history details, event registration details, event organizer details, event attendee details, ticket purchase details, attendee check-in details, and event displays. Event management system 282 may be accessed by the other components of system 200, either directly or via network 286. Event management system 282 represents any components that may communicate with computing server 138 of gatekeeper system 114 in order to update ticket information 328 stored on computing server 138 and further to update a master ticket information 328 stored on event management system 282. Event management system 282 may include any suitable computing device, such as, for example, a network server, any remote server, a mainframe, a host computer, a workstation, a personal computer, or a laptop.

Network 286 may be any suitable communications network. As an example and not by way of limitation, one or more portions of network 286 may include an ad hoc network, an intranet, an extranet, a virtual private network (VPN), a LAN, a WLAN, a wireless WAN (WWAN), a metropolitan area network (MAN), a portion of the Internet, a portion of the Public Switched Telephone Network (PSTN), a cellular telephone network, or a combination of two or more of these. Network 286 may include one or more networks 286. According to the illustrated embodiment, network 286 may connect gatekeeper systems 114 to event management system 282.

As is discussed in FIG. 1, gatekeeper system 114 may provide the indication of validity 146 of the ticket 174 presented by a spectator attempting to enter an event. As is illustrated, gatekeeper system 114 may include computing server 138. Computing server 138 may represent any component that determines the indication of validity 146 of ticket 174, and communicates the indication of validity 146. Computing server 138 may include any suitable computing device, such as, for example, a network server, any remote server, a mainframe, a host computer, a workstation, a personal computer, a laptop, a cellular phone, a smartphone, a personal digital assistant, an ultra-mobile PC, or a computing tablet. Particular embodiments of computing server 138 are further described in FIG. 3.

Network 290 may be any suitable communications network. As an example and not by way of limitation, one or more portions of network 290 may include an ad hoc network, an intranet, an extranet, a VPN, a LAN, a WLAN, a WWAN, a MAN, a portion of the Internet, a portion of the PSTN, a cellular telephone network, or a combination of two or more of these. Network 290 may include one or more networks 290. Furthermore, although network 290 and network 286 are illustrated as different networks, in particular embodiments, network 290 and network 286 may be the same network. According to the illustrated embodiment, network 290 may connect mobile check-in devices 170 to gatekeeper system 114.

Network 292 may be any suitable communications network. As an example and not by way of limitation, one or more portions of network 292 may include an ad hoc network, an intranet, an extranet, a VPN, a LAN, a WLAN, a WWAN, a MAN, a PAN, a portion of the Internet, a portion of the PSTN, a cellular telephone network, or a combination of two or more of these. Network 292 may include one or more networks 292. Furthermore, although network 292 and network 290 are illustrated as different networks, in particular embodiments, network 292 and network 290 may be the same network. According to the illustrated embodiment, network 292 may connect mobile check-in devices 170 together.

In an example embodiment of operations, event management system 282 may include a master ticket information 328 for a particular event. Once gatekeeper system 114 is connected to event management system 282 through network 286, event management system 282 may send an initial message 202 to gatekeeper system 114. In particular embodiments, initial message 202 may include ticket information 328 for the event. In particular embodiments, ticket information 328 may be an exact copy of the master ticket information 328 stored at event management system 282. As such, by receiving initial message 202, computing server 138 of gatekeeper system 114 may have a list of all ticket identifiers 178 for the event. In particular embodiments once computing server 138 includes the ticket information 328, computing servers 138 may be able to provide an indication of validity 146 for each ticket 174. As such, spectators for the event may be allowed to begin presenting tickets 174 for entry into the event.

Master ticket information 328 represents any information regarding tickets for the event. For example, master ticket information 328 may include a list of ticket identifiers 178 that are valid, a list of ticket identifiers 178 that are not valid, any other information that may be used to manage entry of one or more spectators to the event, or any combination of the preceding. In particular embodiments, master ticket information 328 list is a master list of all the information regarding tickets for the events. As such, if ticket information 328 stored at computing server 138 is lost or corrupted, master ticket information 328 list may be used to provide new ticket information 328 to computing server 138. Furthermore, if any changes occur that affect tickets for the event (such as the purchase of additional tickets 174 or the invalidity of certain ticket identifiers 178), the changes may be added to master ticket information 328. The changes may then be sent to computing servers 138 in order to update ticket information 328.

In particular embodiments, master ticket information 328 may further include any of the information included in ticket information 328 stored at computing servers 138. For example, master ticket information 328 may further include setting information for a mobile check-in device 170 and information regarding event attendees.

In particular embodiments, once a spectator presents ticket 174 to a user of mobile check-in device 170, mobile check-in device 170 may scan ticket identifier 178 from ticket 174 and transmit ticket identifier 178 to computing server 138 through network 290. In particular embodiments, the mobile check-in device 170 may transmit ticket identifier 178 to computing server 138 through a combination of, for example, network 290 and network 292. Computing server 138 may then compare ticket identifier 178 to the ticket information 328 stored at computing server 138. Based on this comparison, computing server 138 may generate the indication of validity 146 of ticket 174, and transmit the indication of validity 146 to mobile check-in device 170.

In addition to generating the indication of validity 146, computing server 138 may further update the ticket information 328 stored on computing server 138 based on the comparison between the stored information and the ticket identifier 178. For example, based on the comparison, computing server 138 may determine that a particular ticket identifier 178 has been scanned, and therefore may update the ticket information 328 to indicate that the particular ticket identifier 178 has been scanned and may no longer be used to allow any other spectators to enter the event. As such, if another spectator attempts to enter the event with a ticket 174 with that same ticket identifier 178, computing server 138 may determine that the particular ticket identifier 178 has already been used, and may provide an indication of validity 146 that indicates that the ticket is not valid. Thus, the spectator may be prevented from entering the event.

In particular embodiments, while computing server 138 is providing on-site management of spectator entry into the event, computing server 138 may further transmit ticket identification message 204 to event management system 282 through network 286. In particular embodiments, ticket indication message 204 may include any information that may cause event management system 282 to update the master ticket information 328 stored on event management system 282. For example, ticket indication message 204 may include an indication that a particular ticket identifier 178 has been scanned by a mobile check-in device 170 and transmitted to computing server 138. As such, event management system 282 may update the master ticket information 328 to indicate that the particular ticket identifier 178 is no longer valid. Therefore, event management system 282 may have a master ticket information 328 that is kept up to date with the transactions occurring on-site.

In particular embodiments, computing server 138 may transmit ticket indication message 204 at any time. For example, ticket indication message 204 may be transmitted to event management system 282 each time computing server receives ticket identifier 178 and compares that ticket identifier 178 to the ticket information 328 stored on computing server 138. As such, each ticket indication message 204 may only include a single ticket identifier 178.

In particular embodiments, computing server 138 may transmit ticket indication message 204 to event management system 282 periodically. For example, computing server 138 may transmit ticket indication message 204 to event management system 282 every few seconds, every few minutes, every few hours, or after any other amount of time. In particular embodiments, when the ticket indication message 204 is transmitted periodically, the ticket indication message 204 may include more than just a single ticket identifier 178. For example, ticket indication message 204 may include one or more of the ticket identifiers 178 that have been scanned and transmitted to computing server 138 since the last time computing server 138 transmitted ticket indication message 204 to event management system 282. In particular embodiments, ticket indication message 204 may include all of the ticket information 328 stored at computing server 138 or may only include an update (such as all of the new information that has been added to the ticket information 328 stored at computing server 138 since the last ticket indication message 204 was sent to event management system 282).

In particular embodiments, computing server 138 may disconnect with event management system 282. In this case, the computing server 138 may manage spectator entry into the event independently of the event management system 282. As an example and not by way of limitation, computing server 138 may use information from the ticket indication messages 204 to update a cached version of a master ticket information 328 that it previously retrieved from the event management system 282. Once the computing server 138 successfully resumes connection with the event management system 282, it may transmit the updated master ticket information 328, and any suitable updated information, to event management system 282.

In particular embodiments, event management system 282 may periodically transmit an update message 208 to computing server 138. Update message 208 may include any indication of one or more changes to the master ticket information 328 list that have occurred since initial message 202 or the last update message 208. In particular embodiments, event management system 282 may transmit update message 208 every few seconds, every few minutes, every few hours, or after any other amount of time.

In particular embodiments, by receiving update message 208, computing server 138 may be able to update the ticket information 328 stored at computing server 138 to match the master ticket information 328 stored at event management system 282. In particular embodiments, this may allow computing server 138 to have the most current ticket information 328. Therefore, if a first computing server 138 has received a particular ticket identifier 178, information regarding that particular ticket identifier 178 may be transmitted to event management system 282, and further transmitted to a second computing server 138. As such, if a spectator attempts to enter the event with a ticket 174 that includes the exact same ticket identifier 178 that was already scanned and transmitted to a first computing server 138, the ticket information 328 at a second computing server 138 may include information that indicates that this particular ticket identifier 178 has already been used for entry. As such, the second computing server 138 may provide an indication of validity 146 that indicates that the ticket identifier 178 is not valid.

Although system 200 illustrates computing server 138 receiving update messages 208 from event management system 282, in particular embodiments, computing server 138 may be unable to connect to event management system 282 (such as when there is no internet connectivity at the event). In such an embodiment, computing server 138 may still include the stored ticket information 328. As such, computing server 138 may still provide on-site management of spectator entry into the event even when computing server 138 is unable to connect to event management 282.

Modifications, additions, or omissions may be made to system 200 without departing from the scope of the invention. For example, although system 200 illustrates a particular arrangement of event management system 282, network 286, gatekeeper systems 114, networks 290, networks 292, and mobile check-in devices 170, this disclosure contemplates any suitable arrangement of event management system 282, network 286, gatekeeper systems 114, networks 290, networks 292, and mobile check-in devices 170. As an example and not by way of limitation, two or more of gatekeeper systems 114 may be connected to each other directly, bypassing event management system 282. Additionally, system 200 may include any suitable number of event management systems 282, networks 286, gatekeeper systems 114, networks 290, networks 292 and/or mobile check-in devices 170. Furthermore, any suitable logic may perform the functions of system 200 and the components within system 200.

Additionally, although system 200 illustrates update messages 208 being transmitted from event management system 282, in particular, update messages 208 may be transmitted directly from a first computing server 138 to a second computing server 138, or vice versa. Furthermore, although system 200 illustrates initial message 202 being received at computing server 138 through network 286, in particular embodiments, initial message 200 (and/or the ticket information 328) may be received at computing server 138 in any other manner.

FIG. 3 illustrates an example computing server 138 of FIG. 1. Computing server 138 may represent any component that determines the indication of validity 146 of ticket 174, and communicates the indication of validity 146. Computing server 138 may include any suitable computing device, such as, for example, a network server, any remote server, a mainframe, a host computer, a workstation, a personal computer, a laptop, a cellular phone, a smartphone, a personal digital assistant, an ultra-mobile PC, or a computing tablet. In the illustrated embodiment, computing server 138 may include a network interface 312, a processor 316, and a memory 320.

Network interface 312 may represent any device operable to receive information from a network (such as network 286 and/or network 290 of FIG. 2), transmit information through the network, perform processing of information, communicate to other devices, or any combination of the preceding. For example, network interface 312 receives ticket identifier 178 from mobile check-in device 170. As another example, network interface 312 communicates the indication of validity 146 to mobile check-in device 170. Network interface 312 may represent any port or connection, real or virtual, including any suitable hardware and/or software, including protocol conversion and data processing capabilities, to communicate through a LAN, a MAN, a WAN, or other communication system that allows computing server 138 to exchange information with the network, mobile check-in devices 170, event management system 282, other components of system 110 of FIG. 1, or other components of system 200 of FIG. 2.

Processor 316 may communicatively couple to network interface 312 and memory 320, and control the operation and administration of computing server 138 by processing information received from network interface 312 and memory 320. Processor 316 may include any hardware and/or software that operates to control and process information. For example, processor 316 executes application 324 to control the operation of computing server 138. Processor 316 may be a programmable logic device, a microcontroller, a microprocessor, any processing device, or any combination of the preceding.

Memory 320 may store, either permanently or temporarily, data, operational software, or other information for processor 316. Memory 320 may include any one or a combination of volatile or non-volatile local or remote devices suitable for storing information. For example, memory 320 may include random access memory (RAM), read only memory (ROM), magnetic storage devices, optical storage devices, or any other information storage device or a combination of these devices. While illustrated as including particular modules, memory 320 may include any information for use in the operation of computing server 138.

In the illustrated embodiment, memory 320 may include application 324 and ticket information 328. Application 124 may represent any suitable set of instructions, logic, or code embodied in a computer-readable storage medium and operable to facilitate the operation of computing server 138.

Ticket information 328 may represent any information regarding tickets for the event. For example, ticket information 328 may include a list of ticket identifiers 178 that are valid, a list of ticket identifiers 178 that are not valid, any other information used to manage entry of one or more spectators to the event, or any combination of the preceding. In particular embodiments, when computing server 138 receives a particular ticket identifier 178 from mobile check-in device 170, computing server 138 may access ticket information 328 in order to compare ticket information 328 to the ticket identifier 178. In particular embodiments, if the ticket information 328 indicates that the ticket identifier 178 is valid (such as by determining that ticket identifier 178 was listed as a valid ticket identifier 178), computing server 138 may generate an indication of validity 146 that indicates that ticket 174 is valid.

In particular embodiments, ticket information 328 may further include mobile check-in device setting information. For example, as is discussed above, certain tickets may be given a priority over other tickets. As an example, a higher priced ticket may allow a spectator to enter the event earlier, or from a different gate than lower priced tickets. In particular embodiments, mobile check-in device setting information may include information that indicates which tickets 174 are allowed to be used at particular mobile check-in devices 170. For example, if a particular mobile check-in device 170 is being used at Gate A (which is a gate that may only be accessed by spectators with a ticket 174 that has a Gate A priority), mobile check-in device setting information may include information that indicates that the particular mobile check-in device 170 can only allow entry to spectators that include a ticket 174 with the Gate A priority. As such, if mobile check-in device 170 scans a ticket identifier 178 of a ticket 174 that does not include a Gate A priority, computing server 138 may transmit an indication of validity 146 to mobile check-in device 170 that indicates that the ticket 174 is valid, but not at that gate. The user of mobile check-in device 170 may then direct the spectator to attempt entry to the event at another gate.

In particular embodiments, ticket information 328 may further include information regarding event attendees. For example ticket information 328 may include information describing one or more of the attendees registered to attend the event, include the attendee's name, phone number, mailing address, email address, payment information, ticket order information, ticket information, check-in status, and other suitable attendee information.

FIG. 4 illustrates an example block diagram of mobile check-in device 170 of FIG. 1. In particular embodiments, mobile check-in device 170 may represent any component that communicates with computing server 138 in order to receive the indication of validity 146 of ticket 174. In particular embodiments, mobile check-in device 170 may include any suitable computing device, such as, for example, a personal computer, a laptop, a cellular phone, a smartphone, a personal digital assistant, an ultra-mobile PC, or a computing tablet. In particular embodiments, mobile check-in device 170 may include any mobile computing system available from Apple, such as the Apple IPAD or IPHONE, or any mobile system available from any other mobile device manufacturer or provider. In the illustrated embodiment, mobile check-in device 170 may include a network interface 440, a processor 444, and a memory 448.

Network interface 440 may represent any device operable to receive information from a network (such as network 290 and/or network 292 of FIG. 2), transmit information through the network, perform processing of information, communicate to other devices, or any combination of the preceding. For example, network interface 440 may communicate ticket identifier 178 to computing server 138. As another example, network interface 440 may receive the indication of validity 146 from computing server 138. Network interface 440 may represent any port or connection, real or virtual, including any suitable hardware and/or software, including protocol conversion and data processing capabilities, to communicate through a LAN, a MAN, a WAN, or other communication system that allows mobile check-in device 170 to exchange information with the network, computing server 138, other components of system 110 of FIG. 1, or other components of system 200 of FIG. 2.

Processor 444 may communicatively couple to network interface 440 and memory 448, and control the operation and administration of mobile check-in device 170 by processing information received from network interface 440 and memory 448. Processor 444 may include any hardware and/or software that operates to control and process information. For example, processor 444 executes application 452 to control the operation of mobile check-in device 170. Processor 444 may be a programmable logic device, a microcontroller, a microprocessor, any processing device, or any combination of the preceding.

Memory 448 may store, either permanently or temporarily, data, operational software, or other information for processor 444. Memory 448 may include any one or a combination of volatile or non-volatile local or remote devices suitable for storing information. For example, memory 448 may include RAM, ROM, magnetic storage devices, optical storage devices, or any other information storage device or a combination of these devices. While illustrated as including particular modules, memory 448 may include any information for use in the operation of mobile check-in device 170.

In the illustrated embodiment, memory 448 may include application 452 and status indicators 456. Application 452 may represent any suitable set of instructions, logic, or code embodied in a computer-readable storage medium and operable to facilitate the operation of mobile check-in device 170.

Status indicators 456 may represent any information regarding the status of mobile check-in device 170. For example, status indicators 456 may include a battery level of mobile check-in device 170, a wireless connection signal of mobile check-in device 170, scanning problem indications at mobile check-in device 170 (such as the user of mobile check-in device 170 improperly scanning ticket identifier 178 or the number of tickets 174 that have been presented at the wrong mobile check-in device 170), any other status indicators of mobile check-in device 170, or any combination of the preceding. In particular embodiments, mobile check-in device 170 may retrieve status indicators 456 by monitoring the status of mobile check-in device 170 in any manner. In particular embodiments, mobile check-in device 170 may transmit status indicators 456 to computing server 138.

### Mobile Check-in Tools

FIGS. 5A thru 5G illustrate an example mobile check-in device 170. In particular embodiments, a plurality of mobile check-in devices 170 may be used to facilitate checking-in a plurality of attendees to an event. Although this disclosure describes particular components performing particular processes to facilitate checking-in a plurality of attendees to an event, this disclosure contemplates using any suitable components and any suitable processes to facilitate checking-in a plurality of attendees to an event.

In particular embodiments, the mobile check-in device 170 may include a display 590, a user interface 540, and a camera 550. The mobile check-in device 170 may also host one or more applications, such as, for example, an application for facilitating checking-in one or more attendees to an event. Although FIGS. 5A thru 5G illustrate a particular arrangement of display 590, user interface 540, and camera 550, this disclosure contemplates any suitable arrangement of display 590, user interface 540, and camera 550. As an example and not by way of limitation, both display 590 and camera 550 may be located on the front of the mobile check-in device 170. As another example and not by way of limitation, display 590, camera 550, or both may be independent systems connected to mobile check-in device 170 by a suitable connection. Moreover, although FIGS. 5A thru 5G illustrate a particular number of displays 590, user interfaces 540, and cameras 550, this disclosure contemplates any suitable number of displays 590, user interfaces 540, and cameras 550. As an example and not by way of limitation, mobile check-in device 170 may include multiple displays 590, user interfaces 540, and cameras 550.

In particular embodiments, a mobile check-in device 170 may be a network-addressable mobile computing system that can host one or more applications. A mobile check-in device 170 may generate, store, receive, and transmit event information, event listings, event attendee lists, event check-in data, and other suitable event information. Event check-in data may include, for example, event details, event organizer details, ticket details, attendee details, and other suitable event check-in data. A mobile check-in device 170 may be accessed by one or more gatekeeper systems 114, either directly or via a suitable network, such as network 290. A mobile check-in device 170 may be accessed by one or more different mobile check-in devices 170, either directly or via a suitable network such as network 292. In particular embodiments, one or more event organizers may use one or more mobile check-in devices 170 to access, send data to, and receive data from a gatekeeper system 114. A mobile check-in device 170 may access a gatekeeper system 114 directly, via network 290, via a different mobile check-in device 170, or via a third-party system. Although this disclosure describes and FIGS. 5A thru 5G illustrate a mobile check-in device 170 as a particular type of client device, this disclosure contemplates a mobile check-in device 170 as any suitable type of client device. As an example and not by way of limitation, mobile check-in device 170 may be a smartphone, a personal computer, a laptop computer, a cellular phone, a smartphone, a personal digital assistant, an ultra-mobile PC, a computer tablet, another suitable client system, or two or more such client systems.

In particular embodiments, a mobile check-in device 170 may include one or more displays 590. The display 590 may render, visualize, display, message, and publish to one or more users based on output from a mobile check-in device 170. Output from the mobile check-in device 170 can be transmitted to the display 590 by any suitable connection. The display 590 can include any suitable I/O device that can enable communication between a user and display 590. As an example and not by way of limitation, the display 590 may include a video monitor, speaker, touchscreen, printer, another suitable I/O device, or a combination of two or more of these. Although this disclosure describes and FIGS. 5A thru 5G illustrate a display 590 as a particular type of I/O device, this disclosure contemplates a display 590 as any suitable type of I/O device.

In particular embodiments, a mobile check-in device 170 may receive user-input from one or more users via display 590. As an example and not by way of limitation, display 590 may be a type of touchscreen, such as a resistive touchscreen, a capacitive touchscreen, an infrared touchscreen, or another suitable type of touchscreen. The user may click, touch, or otherwise interact with display 590 to select and input commands and to perform other actions. Although this disclosure describes and FIGS. 5A thru 5G illustrate a mobile check-in device 170 receiving user-input via a particular component, this disclosure contemplates mobile check-in device 170 receiving user-input via any suitable I/O interface. As an example and not by way of limitation, mobile check-in device 170 may receive user-input via keyboard, keypad, microphone, monitor, mouse, printer, scanner, speaker, still camera, stylus, tablet, trackball, video camera, another suitable I/O device, or a combination of two or more of these.

In particular embodiments, a mobile check-in device 170 may receive user-input from one or more users via a user interface 540 that is displayed on a display 590. As an example and not by way of limitation, user interface 540 may be a graphic user interface that allows one or more users to interact with the mobile check-in device 170. A user may click, touch, or otherwise interact with the user interface 540 to provide input to the mobile check-in device 570.

The user interface 540 may be generated by any suitable program or application. As an example and not by way of limitation, the user interface 540 may be provided in a structured document and processed by a browser client of the mobile check-in device 170. A user of a mobile check-in device 170 can use the browser client or other application to access a user interface 540 over a network (such as, for example, network 290 or network 292). The user interface 540 may be automatically generated and presented to the user in response to the user visiting or accessing a gatekeeper system 114, a third-party website, or executing an application on mobile check-in device 170. As another example and not by way of limitation, the user interface 540 may be provided by a dedicated client application hosted on the mobile check-in device 170.

In particular embodiments, gatekeeper system 114 may transmit data to a mobile check-in device 170 allowing it to display user interface 540, which may be some type of graphic user interface. As an example and not by way of limitation, a webpage downloaded to mobile check-in device 170 may include an embedded call that causes mobile check-in device 170 to download an executable object, such as a Flash .SWF object, which executes on the mobile check-in device 170 and renders some or all of the user interface 540 within the context of the webpage. Other interface types may be possible, such as server-side rendering and the like. User interface 540 may be configured to receive signals from the user via mobile check-in device 170. As an example and not by way of limitation, a user may touch or click on user interface 540, or enter commands from a keyboard, keypad, or other suitable input device. The mobile check-in device 170 may respond to these signals and may transmit these signals to the gatekeeper system 114. The display of user interface 540 may change based on the output of the gatekeeper system 114, the input of the user, or signals from mobile check-in device 170.

In particular embodiments, a mobile check-in device 170 may include one or more cameras 550. The camera 550 may capture/scan and store images. The camera 550 may support taking photographs, video, or other suitable images. The camera 550 may include a view finder. In particular embodiments, the display 590 may function as a view finder for the camera 550. Images captured by the camera 550 may be stored on the mobile check-in device 170, transmitted to gatekeeper system 114, transmitted to another mobile check-in device 170, or transmitted to another suitable system.

In particular embodiments, a mobile check-in device 170 may receive from a gatekeeper system 114 directly, or from the gatekeeper system 114 indirectly via one or more third-party mobile check-in devices 170, one or more event listings. Each event listing corresponds to an event. As an example and not by way of limitation a client application hosted on mobile check-in device 170 may download one or more files that include the one or more event listings. The mobile check-in device 170 may also download event information associated with each event listing. The mobile check-in device 170 may receive a particular set of event listings available on the gatekeeper system 114. As an example and not by way of limitation, the gatekeeper system 114 may transmit event listings associated with a particular event organizer. As another example and not by way of limitation, the gatekeeper system 114 may only transmit event listings within a particular date range. Although this disclosure describes a mobile check-in device 170 using particular processes for receiving event listings, this disclosure contemplates a mobile check-in device 170 using any suitable processes for receiving event listings.

In particular embodiments, a mobile check-in device 170 may select an event listing from one or more event listings. As an example and not by way of limitation, a plurality of event listings may be displayed on a display 590. A user may then review the event listings via a user interface 540. The user may then provide input to user interface 540 to select a particular event listing from a plurality of event listings. Although this disclosure describes particular processes for selecting an event listing, this disclosure contemplates any suitable processes for selecting an event listing.

In particular embodiments, a mobile check-in device 170 may receive from a gatekeeper system 114, directly or indirectly, an event attendee list associated with an event. The event attendee list may identify the name, email address, ticket identifier, check-in status, and other suitable attendee information for each attendee registered for the event. The check-in status identifies whether an attendee is checked-in or not checked-in. As an example and not by way of limitation, the event organizer may download the event attendee list from gatekeeper system 114 and store the event attendee list locally on a mobile check-in device 170. The event attendee list may be displayed in whole or in part on display 590. A user may then review the event attendee list via a user interface 540. The user may be able to search the event attendee list for particular attendees, such as, for example, searching by name, email address, ticket identifier, or another suitable search parameter. The user may then provide input to user interface 540 to select one or more attendees from the event attendee list. Although this disclosure describes particular systems receiving and transmitting an event attendee list, this disclosure contemplates any suitable systems receiving and transmitting an event attendee list.

In particular embodiments, a mobile check-in device 170 may check-in one or more attendees. The event attendee list may identify the check-in status for each attendee registered for the event. Check-in status may indicate whether an attendee is or is not checked-in at the event. As an example and not by way of limitation, an event attendee list may be displayed in whole or in part on display 590. The event attendee list may indicate that one or more attendees are not checked in. A user may then select one or more of the attendees and change their check-in status to indicate that they are checked-in. In particular embodiments, the mobile check-in device 170 may receive an indication that the attendee has arrived at an event. As an example and not by way of limitation, a user may access an event attendee list on mobile check-in device 170 and select an attendee from the list to indicate that an attendee had arrived. As another example and not by way of limitation, a user may access an event attendee list on mobile check-in device 170, select an attendee from the list, and provide further input to indicate that an attendee had arrived. In particular embodiments, the mobile check-in device 170 may search the event attendee list for the name, email address, or ticket identifier of the attendee and then select the attendee from the event attendee list. The user may input one or more search criteria into the mobile check-in device 170. The mobile check-in device 170 may then search the event attendee list and identify one or more users that match the search criteria. The user may then select one or more attendees from the search results provide by the mobile check-in device 170. In particular embodiments, the mobile check-in device 170 may scan a ticket for a ticket identifier and identify the attendee based on the ticket identifier. The ticket identifier may be a barcode, a 2D barcode, a QR code, or another suitable scannable identifier. A ticket identifier may be scanned using any suitable scanning device, such as, for example a camera 550, an optical scanner, a barcode scanner, a QR code scanner, or another suitable scanning device. As an example and not by way of limitation, a user may access an event attendee list on mobile check-in device 170 and then scan one or more ticket identifiers from one or more tickets using camera 550. The mobile check-in device 170 may then automatically provide an indication that the attendee associated with the scanned ticket identifier has arrived. In particular embodiments, the mobile check-in device 170 may receive the name, email address, or ticket identifier of the attendee from a third mobile client system associated with the attendee and then identify the attendee based on the received name, email address, or ticket identifier. As an example and not by way of limitation, an attendee may transmit a message or signal (such as, for example, an email, text message, or another suitable signal) to a mobile check-in device 170 containing the attendee's name, email address, or ticket identifier. The mobile check-in device 170 may then automatically provide an indication that the attendee associated with the name, email address, or ticket identifier has arrived. In particular embodiments, the mobile check-in device 170 may update the check-in status of the attendee to identify that the attendee is checked-in. As an example and not by way of limitation, after receiving an indication that an attendee has arrived at an event, a mobile check-in device 170 may access an event attendee list and change the check-in status of the attendee from not checked-in to checked-in. Although this disclosure describes checking-in attendees in a particular manner, this disclosure contemplates checking-in attendees in any suitable manner. Moreover, although this disclosure describes checking-in attendees using particular components, this disclosure contemplates checking-in attendees using any suitable components.

In particular embodiments, a mobile check-in device 170 may periodically transmit to a gatekeeper system 114 an updated event attendee list identifying the one or more attendees checked-in with the mobile check-in device 170. This may be done directly or indirectly via one or more third-party mobile check-in devices 170. An event attendee list may be updated as a mobile check-in device 170 changes the check-in status of attendees. As an example and not by way of limitation, a user may access an event attendee list on a mobile check-in device 170 and update the event attendee list by changing check-in status of one or more attendees to identify that the attendees are checked-in. The mobile check-in device 170 may then transmit the updated event attendee list to a gatekeeper system 114. The mobile check-in device 170 may transmit the updated event attendee list in whole or in part. As an example and not by way of limitation, the mobile check-in device 170 may transmit the entire event attendee list, including data that has been updated and data that has not yet changed. As another example and not by way of limitation, the mobile check-in device 170 may transmit only the part of the event attendee list that has been updated since the last time updates were transmitted to the gatekeeper system 170. Updated event attendee lists may be transmitted between a mobile check-in device 170 and a gatekeeper system 114 at any suitable time. As an example and not by way of limitation, a mobile check-in device 170 may transmit an updated event attendee list after a certain number of attendees have checked-in. As another example and not by way of limitation, a mobile check-in device 170 may transmit an updated event attendee list after a certain time period has passed (such as, for example, every 1, 5, or 10 minutes). Although this disclosure describes transmitting updated event attendee lists between particular components, this disclosure contemplates transmitting update event attendee lists between any suitable components. Moreover, although this disclosure describes transmitting updated event attendee lists at particular times, this disclosure contemplates transmitting updated event attendee lists at any suitable times.

In particular embodiments, a mobile check-in device 170 may periodically receive from a gatekeeper system 114 an updated event attendee list that identifies one or more attendees who have checked-in with one or more other gatekeeper systems 114. This may be done directly or indirectly via one or more third-party mobile check-in devices 170. A plurality of mobile check-in devices 170 may be used to check-in attendees into an event. As the mobile check-in devices 170 are used to check-in attendees, the event attendee list on each mobile check-in device 170 may be updated to identify the attendees that are checked-in by that particular mobile check-in device 170. Each mobile check-in device 170 may then transmit its updated event attendee list to the gatekeeper system 114. In particular embodiments, the event management system 282 may then synchronize the updated event attendee lists from the plurality of mobile check-in devices 170 to create a new event attendee list that contains up-to-date check-in status information for each attendee. In particular embodiments, the gatekeeper system 114 may produce a new updated event attendee list based on one or more updated event attendee lists that it receives from the plurality of mobile check-in devices 170. This new updated event attendee list may then be periodically transmitted directly or indirectly back to the mobile check-in devices 170. The gatekeeper system 114 may transmit the updated event attendee list in whole or in part. As an example and not by way of limitation, the gatekeeper system 114 may transmit the entire event attendee list, including data that has been updated and data that has not yet changed. As another example and not by way of limitation, the gatekeeper system 114 may transmit only the part of the event attendee list that has been updated since the last time updates were transmitted to the mobile check-in devices 170. Updated event attendee lists may be transmitted to a mobile check-in device 170 from a gatekeeper system 114 at any suitable time. As an example and not by way of limitation, a gatekeeper system 114 may transmit an updated event attendee list after a certain number of attendees have checked-in. As another example and not by way of limitation, a gatekeeper system 114 may transmit an updated event attendee list after a certain time period has passed (such as, for example, every 1, 5, or 10 minutes). As an example and not by way of limitation a first user on a first mobile check-in device 170A may check-in a plurality of attendees for an event at the front door to a venue while a second user on a second mobile check-in device 170B may check-in a plurality of other attendees at the rear door to the venue. The first and second mobile check-in devices 170 may periodically transmit their updated event attendee lists to a gatekeeper system 114. The event management system 282 and/or the gatekeeper system 114 may then synchronize this information and transmit a new updated event attendee list to the first and second mobile check-in devices 170. In this way, the first mobile check-in device 170A may receive event information identifying which attendees have checked-in with the second mobile check-in device 170B at the rear door to the venue. Similarly, the second mobile check-in device 170B may receive event information identifying which attendees have checked-in with the first mobile check-in device 170A at the front door to the venue. This may prevent, for example, an attendee from using a particular ticket at one venue entrance and then attempting to use the ticket again at another venue entrance. Although this disclosure describes transmitting updated event attendee lists between particular components, this disclosure contemplates transmitting update event attendee lists between any suitable components. Moreover, although this disclosure describes synchronizing event attendee lists in a particular manner, this disclosure contemplates synchronizing event attendee lists in any suitable manner. Furthermore, although this disclosure describes transmitting updated event attendee lists at particular times, this disclosure contemplates transmitting updated event attendee lists at any suitable times.

In particular embodiments, a mobile check-in device 170 may have a set of privileges on gatekeeper system 114 associated with the event. Privileges on gatekeeper system 114 may include, for example, the ability to create or delete event listings, access particular event information, update particular event information, update particular event attendee lists, or perform other suitable actions or processes on gatekeeper system 114. Privileges may be associated with a particular system mobile check-in device 170 or a particular user. A plurality of mobile check-in devices 170 may be able to access the event information for a particular event listing, and each mobile check-in device 170 may have a particular set of privileges associated with it. As an example and not by way of limitation, one or more first mobile check-in devices 170A may have a first set of privileges on gatekeeper system 114, and one or more second mobile check-in devices 170B may have a second set of privileges on gatekeeper system 114. The second set of privileges may be a superset, a subset, or independent of the first set of privileges. As another example and not by way of limitation, a first user may be the creator of a particular event listing and may have a first set of privileges on gatekeeper system 114 that include the ability to access all event information, including event attendee lists, associated with the particular event listing. One or more second users work as doormen at an event and may have a second set of privileges on gatekeeper system 114 that include only the ability to update the check-in status of attendees on the event attendee list for the particular event listing associated with the event. Although this disclosure describes particular users and systems with particular privileges, this disclosure contemplates any suitable users and systems with any suitable privileges.

In particular embodiments, a mobile check-in device 170 may be used to register one or more attendees for an event. A user of a mobile check-in device 170 may be able to register attendees for an event at the door of the event, for example, as the attendees arrive. A user may select an event to register attendees for. The user may then input information needed to register an attendee, such as, for example, the attendee's personal information and billing information. The mobile check-in device 170 may then update the event attendee list to include the new attendee. As an example and not by way of limitation, an attendee may arrive at an event and not be registered for the event. A user may then take the attendee's personal and billing information and input the information into a mobile check-in device 170. The mobile check-in device 170 may update the event attendee list associated with the event to include the attendee. In particular embodiments, the mobile check-in device 170 may receive payment from the attendee and then update the event attendee list to include the attendee. The mobile check-in device 170 may receive billing information associated with an attendee and process that billing information to receive payment from the attendee. Billing information may include the user's name, address, credit card information, bank account number, PayPal username, and other suitable billing or payment information. The mobile check-in device 170 may also record receipt of cash payment by a user. Billing information may be received in any suitable manner. As yet another example and not by way of limitation, an attendee (who may be registered or unregistered) may arrive at an event and not yet have paid to be registered for the event. A user may take the attendee's billing information and manually input the billing information into a mobile check-in device 170 via the user interface 540. As another example and not by way of limitation, a mobile check-in device 170 may include a credit card reader, which a user can use to swipe and charge credit cards of attendees. After receiving billing information, a mobile check-in device 170 may then process the billing information to transfer funds as appropriate. Funds may be transferred from a financial account provided by the attendee to another suitable financial account (such as, for example, to a financial account associated with the user). As an example and not by way of limitation, a user may input an attendee's credit card information into a mobile check-in device 170. The mobile check-in device 170 may transmit credit card transaction information to a bank or credit card processor to process the charge. After the credit card payment is approved by the bank or credit card processor, the mobile check-in device 170 may update the event attendee list associated with the event to include the attendee. Although this disclosure describes using a mobile check-in device 170 to register for an event in a particular manner, this disclosure contemplates using a mobile check-in device 170 to register for an event in any suitable manner. Moreover, although this disclosure describes a mobile check-in device 170 receiving payment in a particular manner, this disclosure contemplates a mobile check-in device 170 receiving payment in any suitable manner.

FIG. 5B illustrates an example of a mobile check-in device 170 accessing an event listing from event management system 170. The user interface 540 may display a plurality of dates that a user can select. The event listings may be sorted by date, and the user interface shows only dates where the user is managing an event. A user may touch the user interface 540 to select a particular event listing. In the example illustrated, the date “Tuesday, Oct. 26, 2010” is selected, and the user had “Yoga Classes” on that date. Although FIG. 5B illustrates accessing event listings in a particular manner, this disclosure contemplates accessing event listings in any suitable manner.

FIG. 5C illustrates an example of a mobile check-in device 170 accessing an event attendee list from event management system 170. The user interface 540 may include a search query field and display part of an event attendee list for an event listing titled “Yoga Classes.” The search query field may be used to search for an attendee by name or email address. Here, the user has inputted “We” into the search query field, which has returned results of attendees with last names beginning with “We” two of which are displayed in the user interface 540. Although FIG. 5C illustrates accessing an event attendee list in a particular manner, this disclosure contemplates accessing an event attendee list in any suitable manner.

FIG. 5D illustrates an example of a mobile check-in device 170 checking-in an attendee by manually selecting the attendee from the event attendee list. The user interface 540 may display part of the event attendee list for the “Yoga Classes” event listing. The user may select a particular attendee from the event attendee list to check-in that attendee. Here, the user has selected the attendee “Hartz, Kevin” to check-in. After selecting a particular attendee, the user interface 540 will ask the user to confirm the check-in. Here, the user interface 540 displays a “Check In” icon that the user can click to confirm checking-in “Hartz, Kevin.” Although FIG. 5D. illustrates checking-in an attendee in a particular manner, this disclosure contemplates checking-in an attendee in any suitable manner.

FIG. 5E illustrates an example of a mobile check-in device 170 scanning a 2D barcode on a ticket 174 with a camera 550. The ticket 174 is for a “Yoga Class” on the date “October 13.” The ticket 174 may include both a barcode and a 2D barcode. These barcodes may be scanned by any suitable scanning device. Here, a mobile check-in device 170 may function as a scanning device. The camera 550 may scan the 2D barcode. Here, the camera 550 may focus on a 2D barcode on the ticket 174. The user interface 540 may be functioning as a view finder for the camera 550. The mobile check-in device 170 may automatically scan the 2D barcode once it detects the 2D barcode in the view finder. Although FIG. 5E illustrates scanning a particular ticket in a particular manner, this disclosure contemplates scanning any suitable ticket in any suitable manner.

FIG. 5F illustrates an example of a user interface 540 for a mobile check-in device 170 when checking-in an attendee by scanning a 2D barcode on a ticket. FIG. 5F illustrates a more detailed version of the user interface 540 illustrated in FIG. 5E. The user interface 540 may function as a view finder for the camera 550. The ticket 174 from FIG. 5E may be seen on the user interface 540. Overlaying the display from the view finder may be text instructing a user how to scan the 2D barcode from the ticket 174. The user may line up the 2D barcode in the view finder and hold the ticket steady and the mobile check-in device 170 may automatically scan the 2D barcode. Although FIG. 5F illustrates checking-in an attendee by scanning a particular ticket in a particular manner, this disclosure contemplates checking-in an attendee by scanning any suitable ticket in any suitable manner.

FIG. 5G illustrates an example of a mobile check-in device 170 checking-in an attendee by scanning a 2D barcode on a ticket. FIG. 5G illustrates a mobile check-in device 170 identifying and checking-in an attendee after scanning the 2D barcode from a ticket 174, as illustrated in FIGS. 5E and 5F. After scanning the 2D barcode, the mobile check-in device 170 may identify the attendee associated with the 2D barcode ticket identifier. The user interface 540 may then display a confirmation window showing that the ticket is valid, and the attendee's name, email address, ticket type, and payment type. A user may then click on “Check In” to check-in the attendee and update the check-in status of the attendee on the event attendee list to identify that the attendee is checked-in. Although FIG. 5G illustrates checking-in a particular attendee by scanning a ticket in a particular manner, this disclosure contemplates checking-in any suitable attendee by scanning a ticket in any suitable manner.

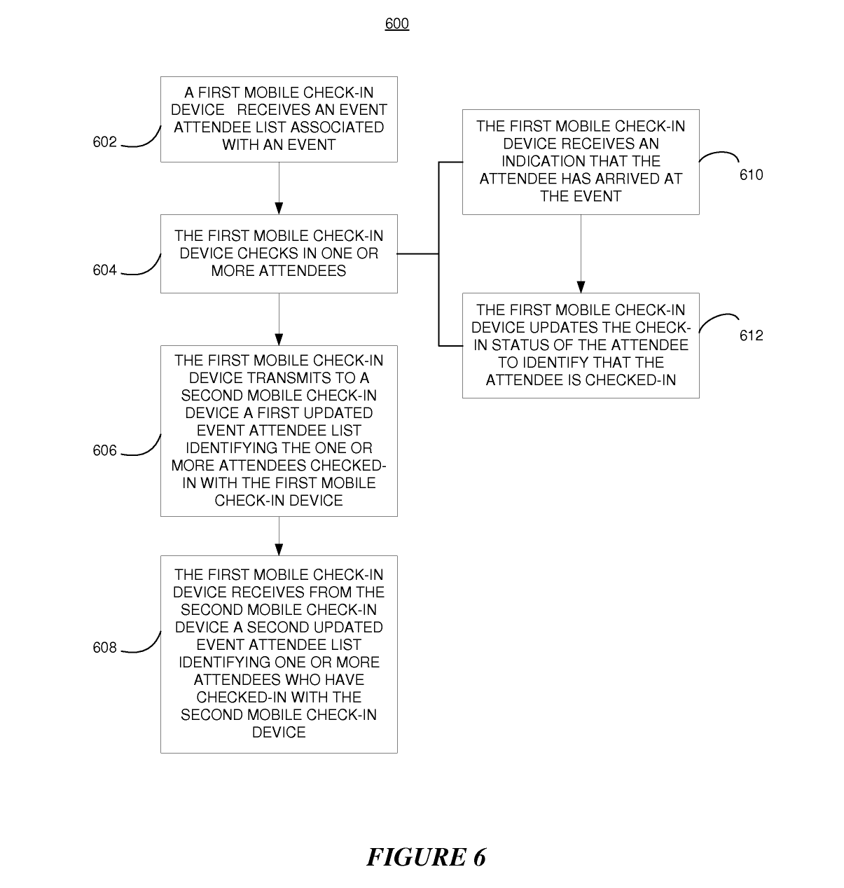

FIG. 6 illustrates an example method 600 for facilitating checking-in one or more attendees with a plurality of mobile check-in devices 170. The method 600 begins at step 602, where a first mobile check-in device 170A receives an event attendee list associated with a first event at any suitable time. As an example and not by way of limitation, the first mobile check-in device 170A may receive an event attendee list when the first mobile check-in device is initially turned on. As another example and not by way of limitation, the first mobile check-in device 170A may receive an event attendee list after a certain time period has passed (such as, for example, every 1, 5, or 10 minutes). In particular embodiments, the first mobile check-in device 170A may be associated with a first check-in location at the event. In particular embodiments, the first mobile check-in device 170A may be associated with a specific user. The event attendee list may identify the name, email address, ticket identifier, and check-in status of each attendee registered for the first event. The check-in status may identify whether an attendee is checked-in or not checked-in. In particular embodiments, the first mobile check-in device 170A may receive the event attendee list from a gatekeeper system 114 if the first mobile check-in device 170A is communicatively connected with the gatekeeper system 114. In particular embodiments, the first mobile check-in device 170A may receive the event attendee list from the gatekeeper system 114 via a second mobile check-in device 170B, if the first mobile check-in device 170A is not communicatively connected with the gatekeeper system 114 while the second mobile check-in device 170B may be able to communicatively connect with the gatekeeper system 114. In particular embodiments, the first mobile check-in device 170A may receive the event attendee list from a second mobile check-in device 170B, even if both first and second mobile check-in devices 170 may not communicatively connect with the gatekeeper system 114. In particular embodiments, the first mobile check-in device 170A may always receive the event attendee list from a pre-determined second mobile check-in device 170B. At step 604, the first mobile check-in device 170A checks-in one or more attendees. Step 604 may comprise substeps 610 and 612. At substep 610, the first mobile check-in device 170A receives an indication that the attendee has arrived at the first event. As substep 612, the first mobile check-in device 170A updates the check-in status of the attendee in the event attendee list to identify that the attendee is checked-in. At step 606, the first mobile check-in device 170A transmits to a second mobile check-in device 170B at any suitable time a first updated event attendee list identifying one or more attendees checked-in with the first mobile check-in device 170A. As an example and not by way of limitation, the first mobile check-in device 170A may transmit the first updated event attendee list after a certain number of attendees have checked-in. As another example and not by way of limitation, the first mobile check-in device 170A may transmit the updated event attendee list after a certain time period has passed (such as, for example, every 1, 5, or 10 minutes). In particular embodiments, the second mobile check-in device 170B may be associated with a second check-in location at the event. In particular embodiments, the second mobile check-in device 170B may be associated with a user different from the user of the first mobile check-in device 170. At step 608, the first mobile check-in device 170A receives from the second mobile check-in device 170B at any suitable time a second updated event attendee list that identifies one or more attendees who have checked-in with the second mobile check-in device 170B. As an example and not by way of limitation, the first mobile check-in device 170A may receive a second updated event attendee list after a certain number of attendees have checked-in with the second mobile check-in device 170B. As another example and not by way of limitation, the first mobile check-in device 170A may receive a second updated event attendee list after a certain time period has passed (such as, for example, every 1, 5, or 10 minutes). Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates particular components carrying out particular steps of the method of FIG. 6, this disclosure contemplates any suitable combination of any suitable components carrying out any suitable steps of the method of FIG. 6. Finally, although this disclosure describes transmitting and receiving event attendee lists at particular times, this disclosure contemplates transmitting and receiving event attendee lists at any suitable times.

### Local SQL Files for Mobile Client System

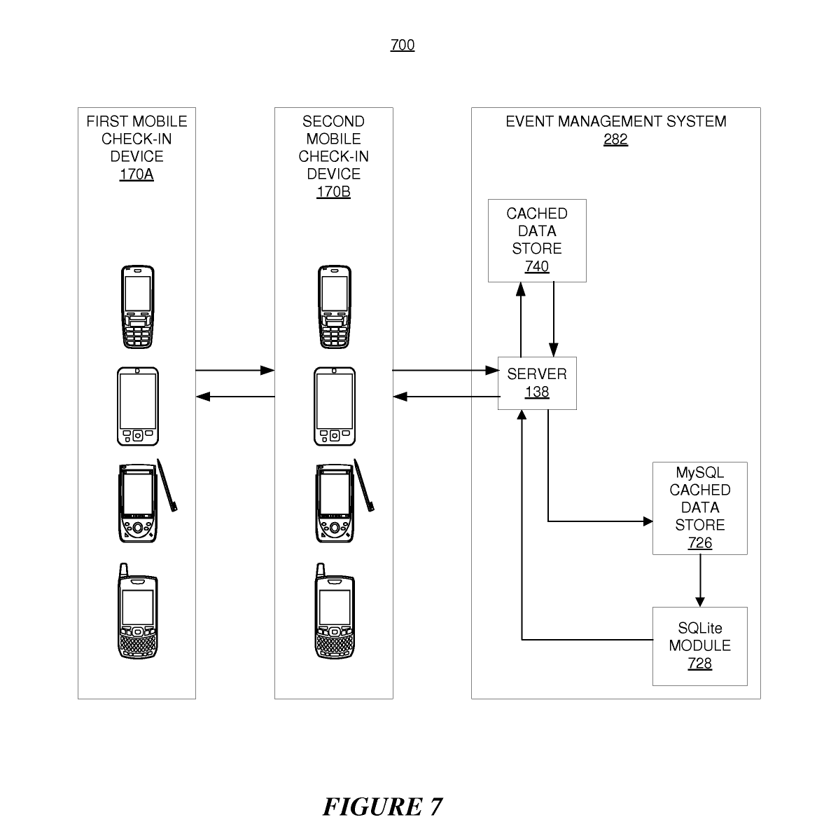

FIG. 7 illustrates an example system 700 for implementing local SQL files for mobile check-in devices 170 with an event management system 282. System 700 may include a first mobile check-in device 170A, a second mobile check-in device 170B, and an event management system 282. It may also include one or more gatekeeper systems 114, via which the mobile check-in devices 170 may communicate with the event management system 282. System 700 may not be connected to an event management system 282. In particular embodiments, first mobile check-in device 170A and second mobile check-in device 170B may be communicatively connected to each other by a suitable network (such as, for example, network 292) or directly. In particular embodiments, second mobile check-in device 170B and computing server 138 of the event management system 282 may be communicatively connected to each other by a suitable network (such as, for example, network 290) or directly. In particular embodiments, first mobile check-in device 170A, second mobile check-in device 170B, and event management system 282 may be communicatively connected to each other by a similar network (such as, for example, network 290 or network 292) or directly. The event management system 282 may include a computing server 138, a cached data store 740, a MySQL cached data store 726, and a SQLite module 728. Although FIG. 7 illustrates a particular arrangement of first mobile check-in device 170A, second mobile check-in device 170B, event management system 282, computing server 138, cached data store 740, MySQL cached data store 726, and SQLite module 728, this disclosure contemplates any suitable arrangement of first mobile check-in device 170A, second mobile check-in device 170B, event management system 282, computing server 138, cached data store 740, MySQL cached data store 726, and SQLite module 728. As another example and not by way of limitation, two or more of computing server 138, cached data store 740, MySQL cached data store 726, and SQLite module 728 may be physically or logically co-located with each other in whole or in part. Moreover, although FIG. 7 illustrates a particular number of first mobile check-in device 170A, second mobile check-in device 170B, event management system 282, computing server 138, cached data store 740, MySQL cached data store 726, and SQLite module 728, this disclosure contemplates any suitable number of mobile check-in devices 170, event management system 282, computing server 138, cached data store 740, MySQL cached data store 726, and SQLite module 728. As an example and not by way of limitation, system 700 may include multiple mobile check-in devices 170, event management system 282, computing servers 138, cached data stores 740, MySQL cached data stores 726, and SQLite modules 728.

In particular embodiments, a gatekeeper system 114 may be a network-addressable computing system that may host one or more event organization and management systems, independent of an event management system 282. A gatekeeper system 114 may generate, store, receive, and transmit event-related data, such as, for example, event listings, event details, event history details, event registration details, event organizer details, event attendee details, ticket purchase details, attendee check-in details, and event displays. A gatekeeper system 114 may be accessed by other components of system 700, either directly or via a suitable network. Each subcomponent of gatekeeper system 114 (i.e., computing server 138, cached data store 740, MySQL cached data store 726, and SQLite module 728) may be accessed by other components of system 700, either directly or via a suitable network. In particular embodiments, a computing server 138 may be any suitable servers, such as Dell POWEREDGE servers, HP PROLIANT servers, Oracle SPARC servers, or computing server 138 of FIG. 3. A cached data store 740 and a MySQL cached data store 726 may be any suitable cached data stores. A data store may store any suitable information, and the contents of a data store may be organized in any suitable manner. As an example and not by way or limitation, the contents of a data store may be stored as a dimensional, flat, hierarchical, network, object-oriented, relational, extensible markup language (XML), or other suitable database or a combination or two or more of these. A data store (or a computing server 138 coupled to it) may include a database-management system or other hardware or software for managing the contents of data store. The database-management system may perform read and write operations, delete or erase data, perform data deduplication, query or search the contents of data store, or provide other access to data store. A cached data store includes all the elements of a data store, and any suitable information downloaded from an event management system 282 that may allow a gatekeeper system 114 of the cached data store to operate without connectivity to an event management system 282. As an example and not by way of limitation, the cached data store may include an initial event attendee list for an event retrieved from an event management system 282. The initial event attendee list may comprise a list of all the attendees who have signed up for the event prior to the start of the event. As another example and not by way of limitation, the cached data store may include a master ticket information 328 previously retrieved from an event management system 282 before the gatekeeper system 114 is disconnected from the event management system 282.

In particular embodiments, gatekeeper system 114 may be a network-addressable computing system that can host one or more applications. A gatekeeper system 114 may access, send data to, and receive data from a mobile check-in device 170 of a mobile check-in device 170. A mobile check-in device 170 may access a gatekeeper system 114 directly, via a suitable network, or via a third-party system. Although this disclosure describes and FIG. 7 illustrates a mobile check-in device 170 as a particular type of client system, this disclosure contemplates a mobile check-in device 170 as any suitable type of client system. As an example and not by way of limitation, mobile check-in device 170 may be a smartphone, a personal computer, a laptop computer, a cellular phone, a smartphone, a personal digital assistant, an ultra-mobile PC, a computer tablet, another suitable client system, or two or more such client systems.

In particular embodiments, gatekeeper system 114 may include one or more computing servers 138 that communicate with one or more mobile check-in devices 170 over a suitable network (such as, for example, network 290). As an example and not by way of limitation, gatekeeper system 114 may have an internet server for communicating with one or more mobile check-in devices 170 via the Internet. As another example and not by way of limitation, gatekeeper system 114 may have a mobile server for communicating with one or more mobile check-in devices 170 via a mobile network (e.g., GSM, PCS, Wi-Fi, WPAN etc.). As yet another example, gatekeeper system 114 may have one server that may communicate with one or more mobile check-in devices 170 over both the Internet and a mobile network. Communication between gatekeeper system 114 and mobile check-in devices 170 may occur over any appropriate electronic communication medium or network using any suitable communications protocols. As an example and not by way of limitation, mobile check-in device 170 and computing server 138 may include Transport Control Protocol/Internet Protocol (TCP/IP) networking stacks to provide for datagram and transport functions. Of course, any other suitable network and transport layer protocols can be utilized.

In particular embodiments, a second mobile check-in device 170B may communicate with gatekeeper system 114 to receive webpages, messages, event attendee list updates, transmit data to and receive data from gatekeeper system 114. In a similar fashion, gatekeeper system 114 may communicate data packets, including hypertext transfer protocol (HTTP) packets, data requests, databases, event attendee lists, event attendee list updates, transaction information, updates, etc.

In particular embodiments, second mobile check-in device 170B may communicate with one or more third-party mobile check-in devices 170, such as for example, first mobile check-in device 170A, over a suitable network (such as, for example, network 292). As an example and not by way of limitation, second mobile check-in device 170B may have an internet server for communicating with one or more third-party mobile check-in devices 170 via the Internet. As another example and not by way of limitation, mobile check-in device 170B may have a mobile server for communicating with one or more third-party mobile check-in devices 170 via a mobile network (e.g., PAN, GSM, PCS, Wi-Fi, WPAN etc.). As yet another example, second mobile check-in device 170B may have one server that may communicate with one or more third-party mobile check-in devices 170 over both the Internet and a mobile network. Communication among the mobile check-in devices 170 may occur over any appropriate electronic communication medium or network using any suitable communications protocols. As an example and not by way of limitation, mobile check-in devices 170 may include Transport Control Protocol/Internet Protocol (TCP/IP) networking stacks to provide for datagram and transport functions. As another example and not by way of limitation, first mobile check-in device 170A and second mobile check-in device 170B may communicate using near field communication (NFC), or any other suitable radio frequency identification (RFID) technologies. Of course, any other suitable network and transport layer protocols can be utilized.

In particular embodiments, a first mobile check-in device 170A may communicate with second mobile check-in device 170B to receive webpages, messages, event attendee list updates, transmit data to and receive data from second mobile check-in device 170B. In a similar fashion, second mobile check-in device 170B may communicate data packets, including HTTP packets, data requests, databases, event attendee lists, event attendee list updates, transaction information, updates, etc.

In addition, hosts or end-systems described herein may use a variety of higher layer communications protocols, including client-server (or request-response) protocols, such as HTTP and other communications protocols, such as HTTP-S, file transport protocol (FTP), simple network management protocol (SNMP), TELNET, and a number of other protocols, may be used. In addition, a server in one interaction context may be a client in another interaction context. Still further, in particular implementations, the information transmitted between hosts may be formatted as hypertext markup language (HTML) documents. Other structured document languages or formats may be used, such as javascript object notation (JSON), SQL, XML, and the like. Executable code objects, such as JavaScript and ActionScript, may also be embedded in the structured documents.

In some client-server protocols, such as the use of HTML over HTTP, a server may generally transmit a response to a request from a client. The response may comprise one or more data objects. For example, the response may comprise a first data object, followed by subsequently transmitted data objects. As an example and not by way of limitation, a client request may cause a server to respond with a first data object, such as an HTML page, which itself refers to other data objects. A client application, such as a browser, may request these additional data objects as it parses or otherwise processes the first data object.

In particular embodiments, gatekeeper system 114 may receive a request from a mobile check-in device 170 for an event attendee list. The request from the mobile check-in device 170 may be in any suitable format. Furthermore the request from the mobile check-in device 170 may be for an initial event attendee list, or any suitable updated event attendee list. The request may be received by computing server 138. As an example and not by way of limitation, the request from the mobile check-in device 170 may be a HTTP request message using an application programming interface (API) for the gatekeeper system 114. As an example and not by way of limitation, a mobile check-in device 170 may send the following HTTP request to gatekeeper system 114:

http://www.eventbrite.com/jsoniphone/event_get_iphone_file?user_key=1279989274532
6696292&app_key=NzFmZDBhZDMwMDk5&show_full_barcodes=true&id=78607918
4&do_not_display=profile,answers,address.

Although this disclosure describes a gatekeeper system 114 receiving a particular request from a mobile check-in device 170, this disclosure contemplates a gatekeeper system 114 receiving any suitable request from a mobile check-in device 170.

In particular embodiments, the event attendee list may be stored as a database. The event attendee list may include information describing one or more of the attendees registered to attend an event, include the attendee's name, phone number, mailing address, email address, ticket order information, payment information, ticket information, check-in status, and other suitable attendee information. The event attendee list may also include information describing the check-in status of an attendee. Check-in status may indicate whether an attendee is or is not checked-in at the event. The event attendee list database may be structured such that there is an entry for each order identifier. Each ticket purchase order may be associated with a particular order identifier, which may be any suitable identifying information. Each order identifier may be associated with one or more attendee identifiers. A user may purchase tickets for an event for himself or others attendees. Each attendee may be associated with a particular attendee identifier, which may be any suitable identifying information. Each attendee identifier may be associated with one or more ticket identifier. An attendee may have one or more tickets. Each ticket may be associated with a particular ticket identifier, which may be any suitable identifying information (such as, for example, a barcode number). In summary, each order identifier may be associated with one or more attendee identifiers, which may be associated with one or more ticket identifiers. In other words, the order identifier→attendee identifier→ticket identifier relationship is a 1→many→many relationship. Each ticket identifier may be associated with a check-in status, which indicates whether or not the ticket associated with the ticket identifier is checked-in or not checked-in. In particular embodiments, the event attendee list may be a SQLite database. SQLite is an embedded SQL database engine. Unlike some SQL databases, SQLite does not have a separate server process. SQLite reads and writes directly to ordinary disk files. A complete SQL database with multiple tables, indices, triggers, and views, is contained in a single disk file. Although this disclosure describes an event attendee list as a particular type of database, this disclosure contemplates an event attendee list as any suitable type of database. As an example and not by way of limitation, an event attendee list may be an Oracle database, a Postgres database, or another suitable type of database. Moreover, although this disclosure describes an event attendee list with a particular database structure, this disclosure contemplates an event attendee list with any suitable database structure.

In particular embodiments, a gatekeeper system 114 may transmit a request to a cached data store 740 for an event attendee list that is a SQLite database. The request may be transmitted by computing server 138. If the event attendee list is available on the cached data store 740 in a SQLite format, the cached data store 740 may respond to the request by transmitting the event attendee list to the computing server 138. If the computing server 138 receives an event attendee list that is a SQLite database from a cached data store 740, the cached data store 740 may then transmit the event attendee list to a second mobile check-in device 170B. However, if the event attendee list is not available on the cached data store 740 in a SQLite format, the cached data store 740 may respond by transmitting a message to the computing server 138 indicating the event attendee list is not available. Although this disclosure describes requesting an event attendee list in a particular manner, this disclosure contemplates requesting an event attendee list in any suitable manner.

In particular embodiments, a gatekeeper 114 may transmit a request to a MySQL cached data store 726 for an event attendee list if the event attendee list is not available on a cached data store 740. The request may be transmitted by computing server 138. In particular embodiments, the event attendee list may be stored as a MySQL database on MySQL cached data store 726. MySQL may be a relational database management system (RDBMS) that runs as a server providing multi-user access to a number of databases. MySQL may be designed for hosting any size of database on a server which may be accessed by a website or an application. Because MySQL is a separate server process and may be run standalone on a server, it may typically require more resources than SQLite. Although this disclosure describes an event attendee list as a particular type of database, this disclosure contemplates an event attendee list as any suitable type of database. Moreover, although this disclosure describes an event attendee list with a particular database structure, this disclosure contemplates an event attendee list with any suitable database structure.

In particular embodiments, a MySQL cached data store 726 may transmit an event attendee list that is a MySQL database to a SQLite module 728. The SQLite module 728 may convert the event attendee list from a MySQL database into a SQLite database. The SQLite module 728 may be any suitable SQLite converter tool. As an example and not by way of limitation, the SQLite module 728 may be database-API wrapper written in the Python programming language. Although this disclosure describes converting an event attendee list from a MySQL database into a SQLite database in a particular manner, this disclosure contemplates converting an event attendee list from a MySQL database into a SQLite database in any suitable manner. In particular embodiments, once the SQLite module 428 has converted the event attendee list into a SQLite database, the SQLite module 728 may transmit the event attendee list to a computing server 138.

In particular embodiments, once a gatekeeper system 114 receives an event attendee list that is a SQLite database, the gatekeeper system 114 may transmit an event attendee list that is a SQLite database to a second mobile check-in device 170B. The request may be transmitted by computing server 138. The event attendee list may be transmitted in any suitable manner. As an example and not by way of limitation, the event attendee list may be transmitted as an HTTP octet-stream via network 290 to one or more mobile check-in devices 170. Although this disclosure describes transmitting an event attendee list in a particular manner, this disclosure contemplates transmitting an event attendee list in any suitable manner. Moreover, although this disclosure describes transmitting an event attendee list with a particular format, this disclosure contemplates transmitting an event attendee list with any suitable format. As an example and not by way of limitation, an event attendee list may be transmitted as an SQLite database, a binary plist, an XML file, a text file, or another suitable file type.

In particular embodiments, a gatekeeper system 114 may periodically receive from a second mobile check-in device 170B an event attendee list update. In particular embodiments, a gatekeeper system 114 may periodically receive from a first mobile check-in device 170A, via a second mobile check-in device 170B, an event attendee list update. An event attendee list may be updated as a mobile check-in device 170 changes the check-in status of attendees. The event attendee list update may identify one or more attendees checked-in with the mobile check-in device 170 since the last time the mobile check-in device 170 transmitted an event attendee list update. In particular embodiments, the event attendee list update may be an API call. As an example and not by way of limitation, a mobile check-in device 170 may transmit the following API call to gatekeeper system 114:

http://www.eventbrite.com/jsoniphone/barcode_update?user_key=127109546641371573
49&barcode=1112979514895461001-used-2-Browse-
2010Z12Z21.23:56:12,1112932514894896001-used-2-Browse-
2010Z12Z21.23:56:44&device_id=iPhone:%20iphonedemo@eventbrite.com&event_id=
651310086&date_modified=2010-12-
22%2007:56:44&app_key=NzFmZDBhZDMwMDk5.

In particular embodiments, the event attendee list update may be a JSON string. The mobile check-in device 170 may then transmit the following JSON sting to gatekeeper system 114:

```
{
barcodes =  {
    id = “1112932514894896001,1112979514895461001”;
    message = “Barcodes updated”;
    status = OK;
  };
}.
```

Although this disclosure describes receiving a particular event attendee list update from a mobile check-in device 170, this disclosure contemplates receiving any suitable event attendee list update from a mobile check-in device 170. Event attendee list updates may be transmitted between a mobile check-in device 170 and a gatekeeper system 114, and between mobile check-in devices 170 at any suitable time. As an example and not by way of limitation, a mobile check-in device 170 may transmit an event attendee list update after a certain number of attendees have checked-in. As another example and not by way of limitation, a mobile check-in device 170 may transmit an event attendee list update after a certain time period has passed (such as, for example, every 1, 5, or 10 minutes). Although this disclosure describes transmitting updated event attendee lists between particular components, this disclosure contemplates transmitting update event attendee lists between any suitable components. Moreover, although this disclosure describes transmitting event attendee list updates at particular times, this disclosure contemplates transmitting event attendee list updates at any suitable times.

In particular embodiments, a gatekeeper system 114 may periodically transmit to a first mobile check-in device 170A, via a second mobile check-in device 170B, an event attendee list update. The event attendee list update may identify one or more attendees who have checked-in with one or more second mobile check-in devices 170B since the last time the first mobile check-in device 170A receives an event attendee list update. In particular embodiments, the event attendee list update may be a JSON string. As an example and not by way of limitation, a JSON string may be:

```
{
  barcodes =  (
        {
      barcode =  {
        “attendee_id” = 14894896;
        “checkin_method” = Browse;
        “checkin_type” = 2;
        “date_created” = “2010-04-19 17:22:27”;
        “date_modified” = “2010-12-22 08:03:00”;
        “device_id” = “iPhone: iphonedemo@eventbrite.com”;
        id = 1112932514894896001;
        status = unused;
      };
    },
        {
      barcode = {
        “attendee_id” = 30220599;
        “checkin_method” = “<null>”;
        “checkin_type” = 0;
        “date_created” = “2010-12-22 08:02:56”;
        “date_modified” = “2010-12-22 08:02:56”;
        “device_id” = “<null>”;
        id = 2338872730220599001;
        status = unused;
      };
    },
        {
      “attendee_summary” =  (
            {
          “attendee_quantity” = 78;
          “checkedin_quantity” = 51;
        }
      );
      summary =  (
            {
          count = 2;
        },
            {
          “count-unused” = 2;
        }
      );
    }
  );
  “new_attendees” =  (
        {
      attendee =  {
        created = “2010-12-22 00:02:45”;
        email = “iphonedemo@eventbrite.com”;
        “event_date” = “”;
        “first_name” = Buford;
        id = 30220599;
        “last_name” = Taylor;
        “order_id” = 23388727;
        “payment_type” = “payment type”;
        price = “0.00 USD”;
        quantity = 1;
        status = 100;
        “ticket_class” = “Sample Ticket”;
      };
    }
  );
  “new_barcodes” =  (
        {
      barcode =  {
        “attendee_id” = 30220599;
        “checkin_method” = “<null>”;
        “checkin_type” = 0;
        “date_created” = “2010-12-22 08:02:56”;
        “date_modified” = “2010-12-22 08:02:56”;
        “device_id” = “<null>”;
        id = 2338872730220599001;
        status = unused;
      };
    }
  );
}.
```

Although this disclosure describes transmitting a particular event attendee list update to a first mobile check-in device 170A, this disclosure contemplates transmitting any suitable event attendee list update to a first mobile check-in device 170A. Event attendee list updates may be transmitted between a gatekeeper system 114 and a mobile check-in device 170 or between mobile check-in devices 170 at any suitable time. As an example and not by way of limitation, a gatekeeper system 114 may transmit an event attendee list update after receiving a certain number of event attendee list updates from a plurality of mobile check-in devices 170. As another example and not by way of limitation, a gatekeeper system 114 may transmit an event attendee list update after a certain time period has passed (such as, for example, every 1, 5, or 10 minutes). As yet another example and not by way of limitation, a gatekeeper system 114 may transmit an event attendee list update after receiving a request from a mobile check-in device 170. Although this disclosure describes transmitting updated event attendee lists between particular components, this disclosure contemplates transmitting update event attendee lists between any suitable components. Moreover, although this disclosure describes transmitting event attendee list updates at particular times, this disclosure contemplates transmitting event attendee list updates at any suitable times.

### Real Time Association of Mobile Client Systems

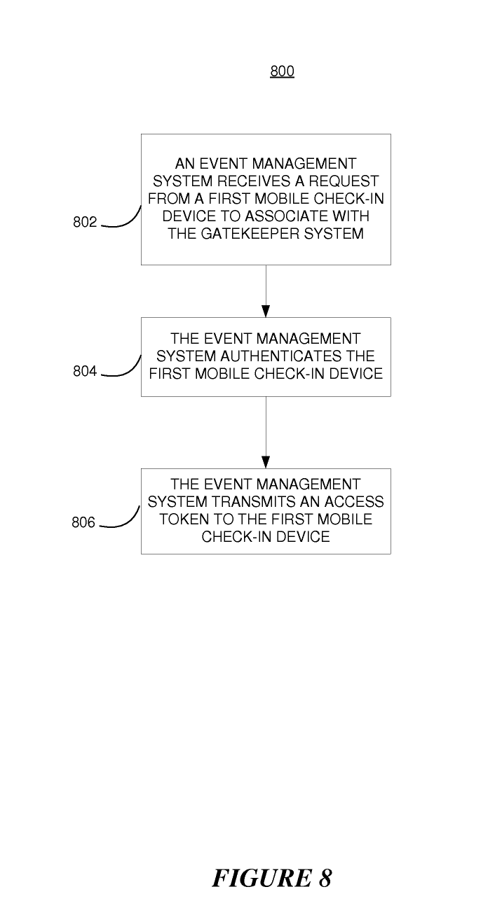

FIG. 8 illustrates an example method 800 for setting up new mobile check-in devices 170 with an event management system 282. The method begins at step 802, where a computing server 138 of an event management system 282 receives a request from a first mobile check-in device 170A of FIG. 7 to associate with the event management system 282. The first mobile check-in device 170A may be any suitable mobile check-in device 170 that has not communicated with the event management system 282. In particular embodiments, the first mobile check-in device 170A may be associated with a new user. In particular embodiments, the first mobile check-in device 170A may be associated with a new check-in location. In particular embodiments, if the first mobile check-in device 170A connects with the event management system 282, it may send the request directly to the event management system 282. In particular embodiments, if the first mobile check-in device 170A could not connect with the event management system 282 but connect indirectly via a second mobile check-in device 170B as illustrated in FIG. 7, it may send the request to the event management system 282 via the second mobile check-in device 170B. At step 804, the computing server 138 authenticates the first mobile check-in device 170A based on a content of the request that it receives from the first mobile check-in device 170A. In particular embodiments, the content of the request may comprise a media access control (MAC) address of the first mobile check-in device 170A, a type of mobile check-in device 170A associated with the first mobile check-in device 170A, one or more users of the first mobile check-in device 170A, and one or more check-in locations of the first mobile check-in device 170A. At step 806, once the computing server 138 authenticates the first mobile check-in device 170A for access to the event management system 282, computing server 138 transmits an access token to the first mobile check-in device 170A. In particular embodiments, if the event management system 282 connects with the first mobile check-in device 170A, it may transmit the access token directly to the first mobile check-in device 170A. In particular embodiments, if the event management system 282 could not connect with the first mobile check-in device 170A but connect indirectly via a second mobile check-in device 170B of FIG. 7, it may transmit the access token to the first mobile check-in device 170A via the second mobile check-in device 170B. In particular embodiments, the access token may have one or more expiration conditions. As an example and not by way of limitation, the access token may expire after a pre-determined time. As another example and not by way of limitation, the access token may expire after a pre-determined number of usages. As yet another example and not by way of limitation, the access token may expire if a mobile check-in device 170 associated with the first mobile check-in device 170A exits a pre-defined check-in location. In particular embodiments, one or more of the mobile check-in devices 170 may auto-discover one or more additional mobile check-in devices 170 and authenticate the additional mobile check-in devices 170 as described above. Although this disclosure describes authenticating a mobile check-in device 170 with an event management system 282, this may also be done, for example, by one or more gatekeeper systems 114, which may then communicate with the event management system 282. Furthermore, although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates particular components carrying out particular steps of the method of FIG. 8, this disclosure contemplates any suitable combination of any suitable components carrying out any suitable steps of the method of FIG. 8.

### Managing Requests for Event Attendee Lists

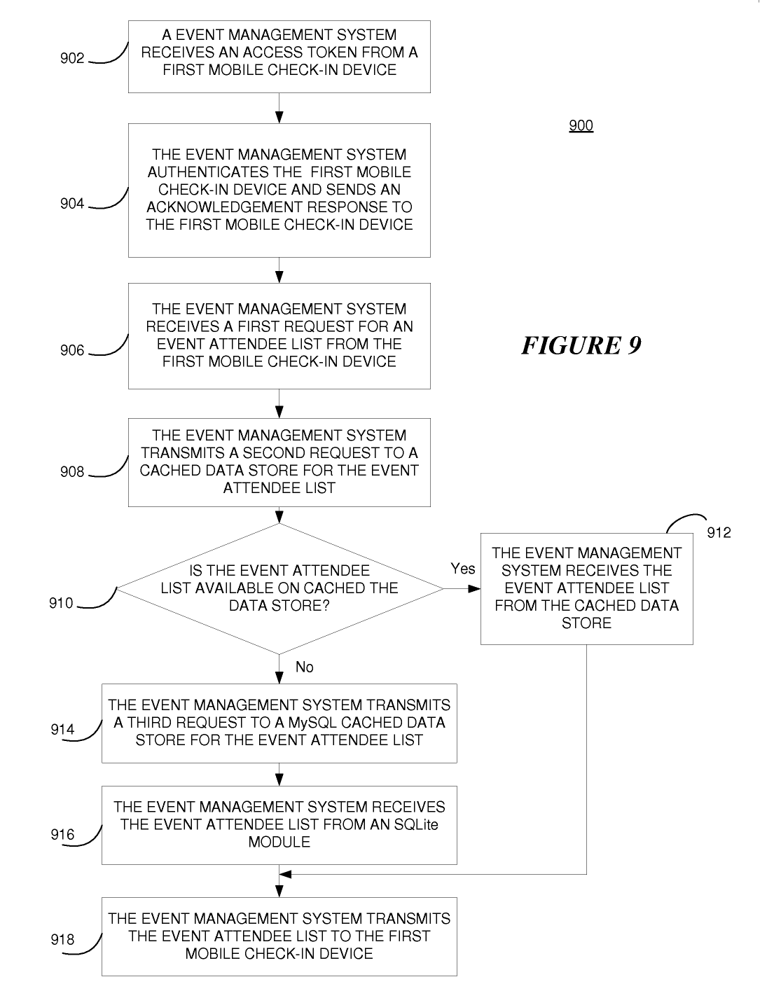

FIG. 9 illustrates an example method 900 for managing requests for event attendee lists from mobile check-in devices 530 by an event management system 282. In particular embodiments, checking-in attendees to an event and updating event attendee lists (which may comprise, for example, ticket barcodes and other event attend information) may be managed in a decentralized way. As an example and not by way of limitation, the plurality of mobile check-in devices may transmit updated event attendee lists to each other, potentially using any one or more suitable algorithms, such as, for example, Paxos, Raft, another suitable algorithm, or any combination thereof. The method begins at step 902, where a computing server 138 of the event management system 282 receives an access token from a first mobile check-in device 170A for authentication and access. In particular embodiments, if the first mobile check-in device 170A connects with the event management system 282, it may send the access token directly to the event management system 282. In particular embodiments, if the first mobile check-in device 170A could not connect with the event management system 282 but connect indirectly via a second mobile check-in device 170B as illustrated in FIG. 7, it may send the request to the event management system 282 via the second mobile check-in device 170B. At step 904, the computing server 138 of the event management system 282 authenticates the first mobile check-in device 170A based on the access token received from the first mobile check-in device 170A, and sends an acknowledgement response to the first mobile check-in device 170A. In particular embodiments, if the event management system 282 connects with the first mobile check-in device 170A, it may transmit the acknowledgement response directly to the first mobile check-in device 170A. In particular embodiments, if the event management system 282 could not connect with the first mobile check-in device 170A but connect indirectly via a second mobile check-in device 170B of FIG. 7, it may transmit the acknowledgement response to the first mobile check-in device 170A via the second mobile check-in device 170B. At step 906, the computing server 138 receives a first request for an event attendee list from the first mobile check-in device 170A. The first mobile check-in device 170A may send the first request to the computing server 138 upon the receipt of the acknowledgement response from the computing server 138. The event attendee list may be stored as a SQLite database and the event attendee list identifies whether an attendee is checked-in or not checked-in. In particular embodiments, if the first mobile check-in device 170A connects with the event management system 282, it may send the first request directly to the event management system 282. In particular embodiments, if the first mobile check-in device 170A could not connect with the event management system 282 but connect indirectly via a second mobile check-in device 170B as illustrated in FIG. 7, it may send the first request to the event management system 282 via the second mobile check-in device 170B. At step 908, the computing server 138 transmits a second request to a cached data store 740 for the event attendee list. At step 910, the computing server 138 may determine if the event attendee list is available on the cached data store 740. If the event attendee list is available on the cached data store 740, then the computing server 138 may receive the event attendee list from the cached data store 740 at step 912. But if the event attendee list is not available on the cached data store 740, then the computing server 138 may transmit a third request to a MySQL cached data store 726 for the event attendee list at step 914. The MySQL cached data store 726 may transmit an event attendee list that is a MySQL database to a SQLite module 728. The SQLite module 728 may convert the event attendee list into a SQLite database. At step 916, the computing server 138 receives the event attendee list from the SQLite module 728. At step 918, the computing server 138 transmits the event attendee list to the first mobile check-in device 170A. In particular embodiments, if the event management system 282 connects with the first mobile check-in device 170A, it may transmit the event attendee list directly to the first mobile check-in device 170A. In particular embodiments, if the event management system 282 could not connect with the first mobile check-in device 170A but connect indirectly via a second mobile check-in device 170B of FIG. 7, it may transmit the event attendee list to the first mobile check-in device 170A via the second mobile check-in device 170B. Although this disclosure describes managing requests for event attendee lists with an event management system 282, this may also be done, for example, by one or more gatekeeper systems 114, which may then communicate with the event management system 282. Furthermore, although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates particular components carrying out particular steps of the method of FIG. 9, this disclosure contemplates any suitable combination of any suitable components carrying out any suitable steps of the method of FIG. 9.

More information on checking in attendees into events may be found in U.S. patent application Ser. No. 12/981,913, filed 30 Dec. 2010, U.S. patent application Ser. No. 13/234,000, filed 15 Sep. 2011, and U.S. patent application Ser. No. 13/566,937, filed 3 Aug. 2012, each of which is incorporated by reference herein.

### Systems and Methods

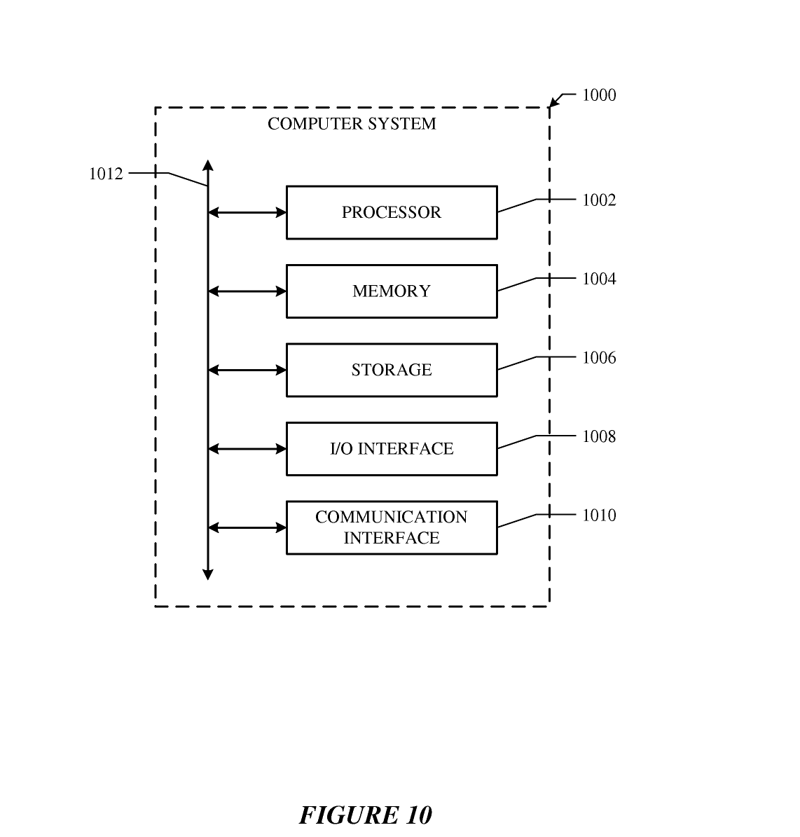

FIG. 10 illustrates an example computer system 1000. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by one or more processors associated with a first mobile check-in device, the first mobile check-in device being associated with a first check-in location of a plurality of check-in locations at a venue for an event:
receiving, by one or more of the processors, an event attendee list associated with the event, the event attendee list identifying, for each of a plurality of attendees of the event:
an attendee identifier associated with the attendee; and
whether the attendee is checked-in or not checked-in;
checking-in, by one or more of the processors, one or more attendees with the first mobile check-in device, wherein checking-in an attendee comprises:
receiving an indication that the attendee has arrived at the event;
updating the check-in status of the attendee in the event attendee list to identify that the attendee is checked-in at the first check-in location associated with the first mobile check-in device;
transmitting, by one or more of the processors, to a second mobile check-in device a first updated event attendee list identifying the attendees checked-in with the first mobile check-in device; and
receiving, by one or more of the processors, from the second mobile check-in device a second updated event attendee list that identifies one or more attendees who have checked-in with the second mobile check-in device.

2. The method of claim 1, wherein the first mobile check-in device is not communicatively connected to a gatekeeper system of an event organizer of the event, and wherein the second mobile check-in device is communicatively connected to the gatekeeper system.

3. The method of claim 2, further comprising:
transmitting, by one or more of the processors, to the gatekeeper system a request to associate with the gatekeeper system; and
receiving, by one or more of the processors, from the gatekeeper system an access token and the event attendee list associated with the event.

4. The method of claim 3, wherein the request is transmitted to the gatekeeper system via the second mobile check-in device, and wherein the access token and the event attendee list are received from the gatekeeper system via the second mobile check-in device.

5. The method of claim 2, wherein the gatekeeper system is communicatively connected to an event management system.

6. The method of claim 2, further comprising:
receiving, by one or more of the processors, from the gatekeeper system via the second mobile check-in device one or more event listings, wherein each event listing corresponds to the event; and
selecting, by one or more users of the first mobile check-in device, a first event listing from the one or more event listings, wherein the first event listing corresponds to the event.

7. The method of claim 6, further comprising:
transmitting, by one or more of the processors, to the gatekeeper system via the second mobile check-in device a request for an event attendee list associated with the first event listing in response to the selection of the first event listing.

8. The method of claim 2, wherein:
the event organizer has a first set of privileges associated with the event on the gatekeeper system; and
each of the first and second mobile check-in devices has a second set of privileges associated with the event on the gatekeeper system, wherein the second set of privileges is a subset of the first set of privileges.

9. The method of claim 1, wherein the first mobile check-in device is not communicatively connected to an event management system, and wherein the second mobile check-in device is communicatively connected to the event management system.

10. The method of claim 1, further comprising:
transmitting, by one or more of the processors, to the gatekeeper system via the second mobile check-in device the first updated event attendee list.

11. The method of claim 1, further comprising:
periodically transmitting, by one or more of the processors, to the second mobile check-in device the first updated event attendee list identifying the one or more attendees checked-in with the first mobile check-in device; and
periodically receiving, by one or more of the processors, from the second mobile check-in device the second updated event attendee list that identifies one or more attendees who have checked-in with the second mobile check-in device.

12. The method of claim 11, wherein periodically transmitting and periodically receiving occurs after a number of checked-in attendees has reached a threshold.

13. The method of claim 1, wherein each of the first and second mobile check-in devices comprises an embedded-database engine, and wherein the event attendee list is a complete structured query language client-side database that is stored on the first and second mobile check-in devices, and executable by the embedded-database engine.

14. The method of claim 1, wherein the event attendee list further identifies, for each of the plurality of attendees of the event:
a ticket identifier associated with a ticket for the event, the ticket being associated with the attendee.

15. The method of claim 14, wherein the ticket identifier is a barcode, a 2D barcode, or QR code.

16. The method of claim 1, wherein the attendee identifier is a name or an email address of the attendee.

17. The method of claim 1, wherein receiving the indication that the attendee has arrived at the event comprises:
receiving an attendee identifier at the first mobile check-in device;
searching the event attendee list for the attendee identifier; and
identifying the attendee corresponding to the attendee identifier from the event attendee list.

18. The method of claim 1, wherein receiving the indication that the attendee has arrived at the event comprises:
scanning the ticket for the ticket identifier associated with the ticket for the event; and
identifying the attendee based on the ticket identifier.

19. The method of claim 1, wherein checking-in the attendee further comprises:
receiving, at the first mobile check-in device, payment from the attendee; and
updating the event attendee list to include the attendee.

20. A system comprising:
a gatekeeper system comprising: a router; a switch; and one or more gatekeeper computing servers for managing ticket information for a plurality of attendees of an event, the one or more gatekeeper computing servers being connected to the switch;
one or more wireless access points, wherein each wireless access point is connected to the switch; and
one or more at least a first and a second mobile check-in devices for checking in the plurality of attendees of the event, wherein each of the first and the second mobile check-in devices is located at one of a plurality of check-in locations at a venue for the event, and wherein at least one of the mobile check-in devices is connected by a wireless connection to the wireless access points, the first mobile check-in device further comprise:
one or more first memories for storing a first set of instructions; and
one or more first processors operable, upon execution of the first set of instructions, to:
receive an event attendee list associated with the event, the event attendee list identifying, for each of the plurality of attendees of the event:
an attendee identifier associated with the attendee; and
whether the attendee is checked-in or not checked-in;
check-in one or more attendees, wherein checking-in an attendee comprises:
receiving an indication that the attendee has arrived at the event;
updating the check-in status of the attendee in the event attendee list to identify that the attendee is checked-in at the first check-in location associated with the first mobile check-in device;
transmit to the second mobile check-in device a first updated event attendee list identifying the attendees checked-in with the first mobile check-in device; and
receive from the second mobile check-in device a second updated event attendee list that identifies one or more attendees who have checked-in with the second mobile check-in device.
